(19) United States
(12) Patent Application Publication
(10) Pub. No.: US 2026/0000578 A1
(43) Pub. Date: Jan. 1, 2026

(54) MULTI-COMPARTMENT CONTAINER AND METHODS OF USE THEREOF

(71) Applicant: ODH IP CORP., NEW YORK, NY (US)

(72) Inventors: Eric A. Van Dyke, Rockville, MD (US); Wesley David Niswander, Rockville, MD (US); Jacob Saxon, Rockville, MD (US); D. Tyler McQuade, Rockville, MD (US); Eugene J. Choi, Falls Church, VA (US); Luke Rogers, Rockville, MD (US); Julian Chesterman, Rockville, MD (US)

(21) Appl. No.: 19/243,625

(22) Filed: Jun. 19, 2025

Related U.S. Application Data
(60) Provisional application No. 63/664,780, filed on Jun. 27, 2024.

(51) Int. Cl. A61J 1/20; A61J 1/10; B65D 81/32

(52) U.S. Cl. CPC A61J 1/2093; A61J 1/10; B65D 81/3266

(57) ABSTRACT

Provided herein is a container that can include a first chamber operable to receive a first ingredient, a second chamber operable to receive a second ingredient, a third chamber operable to receive a third ingredient, a first breakable seal operable to separate the first chamber and the second chamber, and a second breakable seal operable to separate the second chamber and the third chamber. The first breakable seal can be operable to break such that the first ingredient and the second ingredient are mixed to form a first mixture. The second breakable seal can be operable to break such that the third ingredient and the first mixture are mixed to form a second mixture. The first breakable seal can be operable to break prior to the second breakable seal.

### CROSS-REFERENCE TO RELATED APPLICATIONS

This application claims priority to U.S. Provisional Application No. 63/664,780, filed Jun. 27, 2024, the contents of which are entirely incorporated by reference herein.

### GOVERNMENTAL RIGHTS

This invention was made with government support under ONR agreement #N00014-22-9-0016 awarded by the Office of Naval Research. The government has certain rights in the invention.

### FIELD OF DISCLOSURE

The present disclosure relates to multi-compartment containers.

### BACKGROUND

Traditional drug compounding has numerous issues. For example, traditional drug compounding is time consuming and presents substantial risks of contamination. Further, once drugs are compounded, the shelf life of the drug is limited.

Therefore, there is a need for a multi-compartment container that can separately contain drug ingredients and be used as a drug compounder to enhance shelf-life, reduce production time, and mitigate risks of contamination.

### BRIEF DESCRIPTION OF FIGURES

The description will be more fully understood with reference to the following figures and graphs, which are presented as various embodiments of the disclosure and should not be construed as a complete recitation of the scope of the disclosure. It is noted that, for purposes of illustrative clarity, certain elements in various drawings may not be drawn to scale. Understanding that these drawings depict only exemplary embodiments of the disclosure and are not therefore to be considered limiting of its scope, the principles herein are described and explained with additional specificity and detail through the use of the accompanying drawings.

FIG. 1 is a multi-compartment container.

FIG. 2 is a multi-compartment container.

FIG. 3 illustrates two layers of a multi-compartment container.

FIG. 4 illustrates a multi-compartment container.

FIG. 5 illustrates various seals of a multi-compartment container.

FIG. 6 illustrates various seals of a multi-compartment container.

FIG. 7 illustrates a fitment of a multi-compartment container.

FIG. 8 illustrates a use of a multi-compartment container.

FIG. 9 illustrates a use of a multi-compartment container.

FIG. 10 illustrates a use of a multi-compartment container.

FIG. 11A illustrates a multi-compartment container in use.

FIG. 11B illustrates a multi-compartment container in use.

FIG. 11C illustrates a multi-compartment container in use.

FIG. 11D illustrates a multi-compartment container in use.

FIG. 12 illustrates a multi-compartment container.

FIG. 13 illustrates a system for manufacturing a multi-compartment container.

FIG. 14 illustrates a system for manufacturing a multi-compartment container.

FIG. 15 illustrates a system for manufacturing a multi-compartment container.

FIG. 16 illustrates a system for manufacturing a multi-compartment container.

FIG. 17 illustrates a system for manufacturing a multi-compartment container.

FIG. 18 illustrates a system for filling a multi-compartment container.

FIG. 19 illustrates a system for filling a multi-compartment container.

FIG. 20 illustrates a system for filling a multi-compartment container.

FIG. 21A illustrates a station of a system for filling a multi-compartment container.

FIG. 21B illustrates a station of a system for filling a multi-compartment container.

FIG. 21C illustrates a station of a system for filling a multi-compartment container.

FIG. 21D illustrates a station of a system for filling a multi-compartment container.

FIG. 21E illustrates a station of a system for filling a multi-compartment container.

FIG. 21F illustrates a station of a system for filling a multi-compartment container.

FIG. 21G illustrates a station of a system for filling a multi-compartment container.

FIG. 22 illustrates a flow chart of a method.

FIG. 23 illustrates a flow chart of a method for formulating a drug.

Reference characters indicate corresponding elements among the views of the drawings. The headings used in the figures do not limit the scope of the claims.

### DETAILED DESCRIPTION

Various examples of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the example.

Reference to “one example”, “an example”, or “an aspect” means that a particular feature, structure, or characteristic described in connection with the embodiment is included in at least one example of the disclosure. The appearances of the phrase “in one example” or “in one aspect” in various places in the specification are not necessarily all referring to the same example, nor are separate or alternative embodiments mutually exclusive of other example. Moreover, various features are described which may be exhibited by some example and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various examples given in this specification.

As used herein, “about” refers to numeric values, including whole numbers, fractions, percentages, etc., whether or not explicitly indicated. The term “about” generally refers to a range of numerical values, for instance, ±0.5-1%, ±1-5% or ±5-10% of the recited value, that one would consider equivalent to the recited value, for example, having the same function or result.

The term “substantially” is defined to be essentially conforming to the particular dimension, shape or other word that substantially modifies, such that the component need not be exact.

The terms “comprising,” “including” and “having” are used interchangeably in this disclosure. The terms “comprising,” “including” and “having” mean to include, but not necessarily be limited to the things so described.

The term “coupled” as used herein is defined as connected, whether directly or indirectly through intervening components, and is not necessarily limited to physical connections. The connection can be such that the objects are permanently connected or releasably connected.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Provided herein is a multi-compartment container. The multi-compartment container allows for efficient manufacturing of pharmaceutical drugs. For example, traditional drug compounding has various issues. Materials are incorrectly portioned from bulk containers, incorrect materials are used, contamination can occur during compounding, compounding is time consuming due to lengthy handling procedures, compounding is a largely manual process, and pre-mixed materials have shorter stability and expiration times. The multi-compartment container provided herein can be operable to store necessary materials for drug compounding in a single container, while containing the materials separately. In this manner, the multi-compartment container can be ready for drug compounding whenever needed, without reducing the shelf life of the materials. Further, the multi-compartment container can be used as a compounder itself, such that the drug may be formulated in the container when a user needs the drug. The multi-compartment container allows for a single package for drug compounding that is pre-filled with the necessary amounts of ingredients, thereby providing efficient drug compounding while also extending shelf life since the ingredients are separated from one another.

FIG. 1 illustrates a multi-compartment container 100. The multi-compartment container 100 can include a housing 116 that forms a plurality of chambers 101, 103, 105, 107. For example, the housing 116 can be operable to define one or more walls of the plurality of chambers 101, 103, 105, 107. In some examples, the housing 116 can include a flexible material (e.g., able to bend). In some examples, the flexible material can allow for easier storage (e.g., the multi-compartment container 100 can be folded over on itself). In some examples, the flexible material can be operable to allow for easy handling of the multi-compartment container 100 (e.g., the flexible material allows for a user to fold the multi-compartment container 100 during transport).

In some examples, one or more of the plurality of chambers 101, 103, 105, 107 can be operable to receive at least one ingredient 110. For example, in some examples, each chamber 101, 103, 105, 107 can be operable to receive one ingredient 110. In some examples, any of the chambers 101, 103, 105, 107 can be operable to receive more than one ingredient 110. The ingredients 110 can be combined to formulate a pharmaceutical drug. In some examples, the ingredients 110 can include dry ingredients (e.g., powders). In some examples, the ingredients 110 can include liquid ingredients. In some examples, one or more of the plurality of chambers 101, 103, 105, 107 can include a combination of multiple ingredients 111, 112, 113, 114. In some examples, when the ingredients 110 are received in the corresponding chamber 101, 103, 105, 107, the ingredients 110 do not interact with one another across chambers 101, 103, 105, 107, such that their shelf life remains unchanged in an uncombined form. In some examples, the ingredients 110 placed in each of the plurality of chambers 101, 103, 105, 107 can be filled in isolation in a sterile manner. For example, only one chamber of the plurality of chambers 101, 103, 105, 107 is filled at a time (e.g., independent or isolating filling) such that cross contamination is eliminated.

In some examples, the plurality of chambers 101, 103, 105, 107 can have different sizes. For example, to formulate a drug some ingredients 110 can be present in greater amounts than others and thereby require larger and smaller chambers. In some examples, the plurality of chambers 101, 103, 105, 107 can all have the same size (e.g., volume). In some examples, one or more of the plurality of chambers 101, 103, 105, 107 can have a different volume from other chambers of the plurality of chambers 101, 103, 105, 107.

In some examples, the at least one ingredient 110 can include ingredients for injectable and/or intravenous medicines. In some examples, the at least one ingredient 110 can include specific active pharmaceutical ingredients (APIs) and one or more active ingredients. In some examples, the at least one ingredient 110 can include excipients. In some examples, the at least one ingredient 110 can include powders, liquids, gases, gels, tablets, solid objects, instruments, oxygen-sensitive fasteners, tools, sensors, filters, and/or catalysts.

Although four chambers 101, 103, 105, 107 are illustrated in FIG. 1, it will be appreciated that the multi-compartment container 100 can include any number of chambers. For example, the plurality of chambers 101, 103, 105, 107 can include two chambers up to one hundred chambers, any number of chambers therebetween, or more than one hundred chambers.

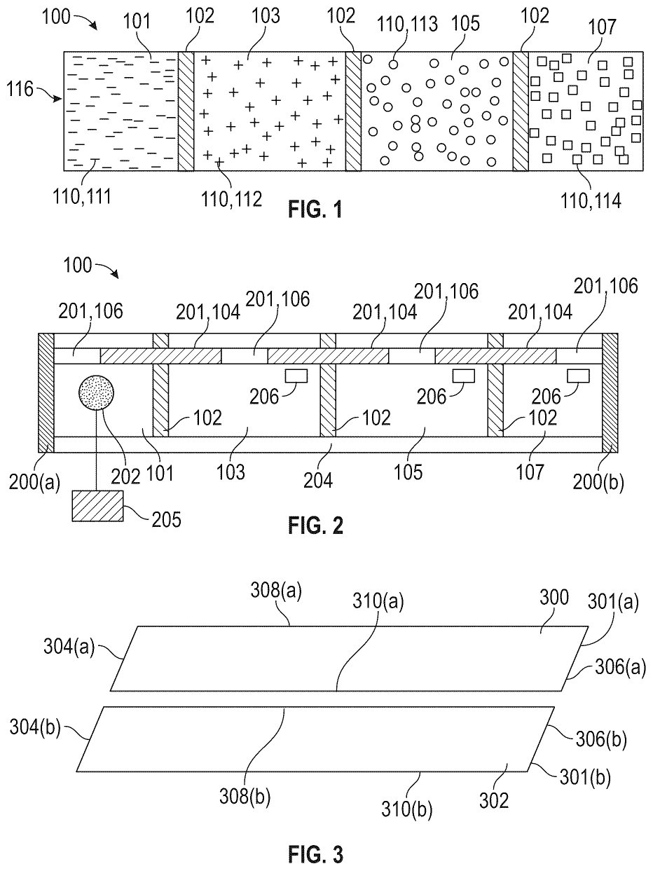

In some examples, the plurality of chambers 101, 103, 105, 107 can be defined by at least one breakable seal 102. For example, a breakable seal 102 can be operable to separate two adjacent chambers 101, 103, 105, 107. The at least one breakable seal 102 can be operable to separate the ingredients 110 between adjacent chambers of the plurality of chambers 101, 103, 105, 107 (e.g., breakable seal 102 can separate first ingredient 111 in first chamber 101 from second ingredient 112 in second chamber 103). In some examples, the at least one breakable seal 102 can form a seal between two adjacent chambers of the plurality of chambers 101, 103, 105, 107 to prevent fluid, solid, and/or gas from passing therethrough. In some examples, the multi-compartment container 100 can include a plurality of breakable seals 102. For example, a breakable seal 102 can be placed between each set of adjacent chambers of the plurality of chambers 101, 103, 105, 107. For example, when the multi-compartment container 100 includes four chambers 101, 103, 105, 107, the multi-compartment container 100 can include three breakable seals 102, as illustrated, for example, in FIGS. 1-2. It will be appreciated that the multi-compartment container 100 can include any number of chambers 101, 103, 105, 107 and similarly a corresponding set of breakable seals 102 to separate adjacent chambers of the plurality of chambers 101, 103, 105, 107.

The at least one breakable seal 102 can be operable to break or be broken under certain conditions. In some examples, the at least one breakable seal 102 can be operable to break so that the ingredients in the two adjacent chambers (e.g., defined by the breakable seal 102) are in communication with one another to be mixed together. In some examples, the at least one breakable seal 102 can be operable to break when a sufficient pressure is provided to the at least one breakable seal 102. In some examples, the breakable seal 102 can be two layers of the housing 116 that are adhered together such that the breakable seal 102 separates as the two layers are pulled apart with sufficient force, whether due to a user pulling the layers apart and/or the prior chamber 101, 103, 105, 107 being filled or manipulated. In some examples, the at least one breakable seal 102 can be soluble, such that the at least one breakable seal 102 breaks when it is exposed to a liquid. In some examples, the at least one breakable seal 102 can be a peelable seal, such that a user can peel the at least one breakable seal 102 and open adjacent chambers (e.g., first chamber 101 and second chamber 103). The at least one breakable seal 102 can have sufficient strength such that the at least one breakable seal 102 does not break under ordinary stress (e.g., does not break during transportation or ordinary movement of the multi-compartment container 100).

In some examples, the at least one breakable seal 102 can have a lower strength than a plurality of permanent seals (e.g., plurality of permanent seals 201 illustrated in FIG. 2). For example, the at least one breakable seal 102 can be operable to break under a specific pressure or force. For example, when one or more of the chambers 101, 103, 105, 107 in fluid communication with the breakable seal 102 receive a pressure that exceeds a predetermined pressure threshold, the breakable seal 102 may break. When the breakable seals 102 are broken, the chambers 101, 103, 105, 107 adjacent to one another on either side of the broken breakable seal 102 are in communication with one another. Accordingly, the plurality of breakable seals 102 can be operable to break such that ingredients 110 in the plurality of chambers 101, 103, 105, 107 can mix together when desired. In some examples, the plurality of breakable seals 102 are configured to break before the material of the multi-compartment container 100 yields.

The plurality of breakable seals 102 can be operable to prevent the at least one ingredient 110 in each chamber (e.g., plurality of chambers 101, 103, 105, 107) from contacting the at least one ingredient 110 in an adjacent chamber (e.g., plurality of chambers 101, 103, 105, 107). In this manner, the multi-compartment container 100 can be operable to hold all of the ingredients 110 needed for a formulation (e.g., drug) separately until a user is ready to form the formulation (e.g., drug). In some examples, a fluid such as water can be added to the multi-compartment container 100 as a final ingredient once the formulation is ready to be formed.

In some examples, the housing 116 can be formed from a plurality of permanent seals 201, as illustrated, for example, in FIG. 2. The plurality of permanent seals 201 can be operable to enclose the ingredients 110 within the plurality of chambers 101, 103, 105, 107.

FIG. 3 illustrates a first layer 300 and a second layer 302 that can be used to form the housing 116 of the multi-compartment container 100. The first layer 300 and the second layer 302 can be coupled together to form the multi-compartment container 100. In some examples, the first layer 300 and the second layer 302 can be sealed along a first layer perimeter 301(a) of the first layer 300 and a second layer perimeter 301(b) of the second layer 302. In some examples, as will be described further herein, only portions of the first layer perimeter 301(a) of the first layer 300 and the second layer perimeter 301(b) of the second layer 302 are sealed together. Then the multi-compartment container 100 is filled, and then the remaining portions of the first layer perimeter 301(a) of the first layer 300 and the second layer perimeter 301(b) of the second layer 302 are sealed.

In some examples, the first layer 300 and/or the second layer 302 can include a material that is non-adhesive. For example, the first layer 300 and/or the second layer 302 can include a material that prevents the ingredients 110 from sticking to the first layer 300 and/or the second layer 302. In some examples, the first layer 300 and the second layer 302 can have certain properties for enhancing shelf-life (e.g., light blocking properties). In some examples, the first layer 300 and/or the second layer 302 can include a plastic material. In some examples, the first layer 300 and/or the second layer 302 can include polyethylene. In some examples, the first layer 300 and/or the second layer 302 can include double wound low intensity polyethylene. The material of the multi-compartment container 100 can be lightweight, such that the multi-compartment container 100 weighs less than a plurality of vials that would typically store the drug. The lightweight material of the multi-compartment container 100 can allow a user to easily transport the multi-compartment container 100 by hand. For example, in some situations, drugs may need to be delivered to areas where traditional transportation of vials (e.g., via truck, boat, etc.) can be difficult. The multi-compartment container 100, due to its lightweight material, can be easier to transport by hand. Further, when a large quantity of a drug is needed, the lightweight material of the multi-compartment container 100 can significantly decrease a total weight that is transported (e.g., the multi-compartment container 100 weighs significantly less than a plurality of glass and/or metal vials). Moreover, the multi-compartment container 100 can be easier to handle than a plurality of typical vials, as the multi-compartment container 100 can contain the same amount of drug as 10, 20, or more vials typically contain. In this manner, the multi-compartment container 100 can provide a singular item to transport instead of numerous vials.

In some examples, the first layer 300 can include a first short edge 304(a), a second short edge 306(a), a first long edge 308(a), and a second long edge 308(b). Similarly, the second layer 302 can include a first short edge 304(b), a second short edge 306(b), a first long edge 308(b), and a second long edge 310(b). The first short edges 304(a), 304(b) can define an end of the multi-compartment container 100. The second short edges 306(a), 306(b) can define an end of the multi-compartment container 100 opposite from the end defined by the first short edges 304(a), 304(b). The first long edges 308(a), 308(b) can define an edge of the multi-compartment container 100 extending from the first short edges 304(a), 304(b) to the second short edges 306(a), 306(b). The second long edges 310(a), 310(b) can define an edge of the multi-compartment container 100 extending from the first short edges 304(a), 304(b) to the second short edges 306(a), 306(b). The second long edges 310(a), 310(b) can define an edge of the multi-compartment container 100 opposite from the first long edges 308(a), 308(b). In some examples, the first short edges 304(a), 304(b) and the second short edges 306(a), 306(b) can have a length that is less than a length of first long edges 308(a), 308(b) and the second long edges 310(a), 310(b).

In some examples, the at least one breakable seal 102 can extend from the first long edge 308(a), 308(b) of the first layer 300 and the second layer 302 to the second long edge 310(a), 310(b) of the first layer 300 and the second layer 302. In other examples, the plurality of breakable seals 102 can be arranged in different orders and locations (e.g., circular chambers defined by breakable seals 102, etc.). For example, the at least one breakable seal 102 can extend only partially between the first long edge 308(a), 308(b) and the second long edge 310(a), 310(b). In some examples, at least one breakable seal 102 can be located in any location or orientation, such that the at least one breakable seal 102 separates the ingredients 110 of two adjacent chambers of the plurality of chambers 101, 103, 105, 107.

As illustrated in FIG. 2, the multi-compartment container 100 can include a plurality of permanent seals 201. The plurality of permanent seals 201 can be operable to connect the first layer 300 to the second layer 302. In some examples, the plurality of permanent seals 201 can be operable to seal at least a portion of the first layer 300 to at least a portion of the second layer 302. In some examples, the plurality of permanent seals 201 can be operable to maintain the connection of the first layer 300 and the second layer 302 during normal operation. For example, the plurality of permanent seals 201 can have a sufficient strength such that the plurality of permanent seals 201 do not break during transport or under certain environmental forces. In some examples, the plurality of permanent seals 201 can be formed using heat, as described further herein. In some examples, the permanent seals 201 are waterproof such that the permanent seals 201 do not allow any liquid to enter or exit the multi-compartment container 100 through the plurality of permanent seals 201. In some examples, the plurality of permanent seals 201 are gas-tight (e.g., gas does not flow through the plurality of permanent seals 201).

In some examples, the plurality of permanent seals 201 can have a higher strength than the at least one breakable seal 102. For example, the plurality of permanent seals 201 can have a higher pressure threshold than the at least one breakable seal 102, such that the breakable seal 102 can break at certain pressures while the permanent seals 201 do not break at the same pressure. In this manner, the breakable seals 102 are operable to break to combine ingredients 110 of adjacent chambers of the plurality of chambers 101, 103, 105, 107, while the permanent seals 201 provide an exterior barrier containing the ingredients 110.

The plurality of permanent seals 201 can include a first short edge seal 200(a). The first short edge seal 200(a) can be operable to connect the first short edge 304(a) of the first layer 300 to the first short edge 304(b) of the second layer 302. In some examples, the first short edge seal 200(a) can be referred to as a terminal seal. The first short edge seal 200(a) can form an edge of the multi-compartment container 100, as illustrated, for example, in FIG. 2.

The plurality of permanent seals 201 can further include a second short edge seal 200(b). The second short edge seal 200(b) can be operable to connect the second short edge 306(a) of the first layer 300 to the second short edge 306(b) of the second layer 302. In some examples, the second short edge seal 200(b) can be referred to as a terminal seal. The second short edge seal 200(b) can form an edge of the multi-compartment container 100, as illustrated, for example, in FIG. 2.

The plurality of permanent seals 201 can further include a long edge seal 204. The long edge seal 204 can be operable to connect the second long edge 310(a) of the first layer 300 to the second long edge 310(b) of the second layer 302. In some examples, the long edge seal 204 seals a bottom edge (e.g., second long edge 310(a)) of the first layer 300 to a bottom edge (e.g., second long edge 310(b)) of the second layer 302. In other examples, the first layer 300 and the second layer 302 can be a single layer that is folded over. In this example, the long edge seal 204 can be the fold line of the single layer that separates the first layer 300 from the second layer 302.

As illustrated in FIGS. 2 and 5-6, in some examples, at least one of the permanent seals 201 can include at least one cross seal 104. The at least one cross seal 104 can be operable to intersect with the at least one breakable seal 102. In some examples, when the at least one breakable seal 102 includes a plurality of breakable seals 102, each breakable seal 102 of the plurality of breakable seals 102 can have a corresponding cross seal 104 of a plurality of cross seals 104. The at least one cross seal 104 can be operable to provide strength to the breakable seal 102 during filling, storage, and/or transport. For example, the at least one cross seal 104 can have a greater strength (e.g., require greater force or pressure to break) than the at least one breakable seal 102. The at least one cross seal 104 can provide strength to the exterior edges of the multi-compartment container 100, such that the at least one breakable seal 102 does not break prematurely. It will be appreciated that any number of cross seals 104 and breakable seals 102 can be included in the multi-compartment container 100. For example, a plurality of breakable seals 102 can have a corresponding plurality of cross seals 104.

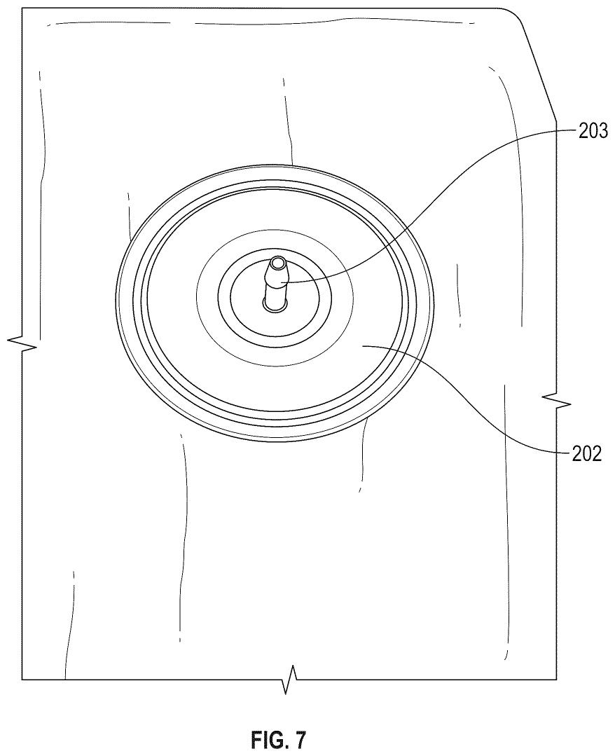

In some examples, the cross seals 104 are located near the first long edge 308(a), 308(b) of the first layer 300 and the second layer 302. In some examples, the cross seals 104 do not extend across the entirety of the first edge 308(a), 308(b) of the first layer 300 and the second layer 302. In some examples, a plurality of openings 108 can be defined between the cross seals 104, as illustrated, for example, in FIGS. 5-6. In some examples, the first short edge seal 201(a) and a cross seal 104 can form at least one opening 108 of the plurality of openings 108, as illustrated, for example, in FIG. 2. In some examples, the second short edge seal 201(b) and a cross seal 104 can form at least one opening 108 of the plurality of openings 108, as illustrated, for example, in FIG. 2. In some examples, the at least one opening 108 can be in communication with a chamber of the plurality of chambers 101, 103, 105, 107. In some examples, the at least one cross seal 104 can provide strength to the at least one breakable seal 102 such that the at least one breakable seal does not break when an ingredient 110 is received in a chamber of the plurality of chambers 101, 103, 105, 107.

The plurality of openings 108 can be operable to receive at least one ingredient 110 into each chamber of the plurality of chambers 101, 103, 105, 107. For example, a user can fill each chamber of the plurality of chambers 101, 103, 105, 107 with at least one ingredient 110 through the plurality of openings 108. In some examples, each chamber of the plurality of chambers 101, 103, 105, 107 can receive at least one ingredient 110 that, when combined with other ingredients 110 of the other chambers of the plurality of chambers 101, 103, 105, 107, can be used to formulate a drug or another formulation. For example, a first chamber 101 can receive a first ingredient 111 through a first opening of the plurality of openings 108. A second chamber 103 can receive a second ingredient 112 through a second opening of the plurality of openings 108. A third chamber 105 can receive a third ingredient 113 through a third opening of the plurality of openings 108. A fourth chamber 107 can receive a fourth ingredient 114 through a fourth opening of the plurality of openings 108. In some examples, as described herein, at least one of the chambers 101, 103, 105, 107 may not receive an ingredient 110 through an opening of the plurality of openings 108. In this example, the chamber 101, 103, 105, 107 not receiving the ingredient 110 through the opening of the plurality of openings 108 can receive an ingredient in a different manner (e.g., through a liquid dispenser, administration device, or other manner) as described herein.

The plurality of permanent seals 201 can further include a plurality of opening seals 106, as illustrated, for example, in FIG. 2. For example, the plurality of opening seals 106 can be operable to permanently seal the plurality of openings 108 once the at least one ingredient 110 has been filled into the plurality of chambers 101, 103, 105, 107. The plurality of opening seals 106 can seal the gaps between the plurality of cross seals 104, such that the entirety of the first long edge 308(a), 308(b) of the first layer 300 and the second layer 302 are sealed together. In this manner, the multi-compartment container 100 can be entirely sealed off from the external environment such that the ingredients 110 are contained within the multi-compartment container 100. In some examples, when the multi-compartment container 100 is entirely sealed off from the external environment, external materials are prevented from contacting the ingredients 110.

While the plurality of openings 108 are described as being defined by gaps between the cross seals 104, it will be appreciated that other types of opening configurations can be used. For example, the cross seals 104 could extend throughout the entirety of the second long edge 310(a), 310(b). The plurality of openings 108 could be located on a front or back side of the plurality of chambers 101, 103, 105, 107. The plurality of openings 108 could then be used to fill the plurality of chambers 101, 103, 105, 107 and the plurality of opening seals 106 can be used to seal the plurality of openings 108, regardless of where the plurality of openings 108 are located.

In some examples, as described further herein, the multi-compartment container 100 can be formed from a flat roll tube as an alternative to using the first layer 300 and the second layer 302. For example, a flat roll tube can include the first layer 300 and the second layer 302 that are pre-sealed with permanent seals 201 along the first long edge 308(a), 308(b) and the second long edge 310(a), 310(b). The flat roll tube can include openings at the first short edge 304(a), 304(b) and the second short edge 306(a), 306(b). The first short edge 304(a), 304(b) and second short edge 306(a), 306(b) can be sealed by permanent seals 201. When a flat roll tube is used to form the multi-compartment container 100, the plurality of openings 108 can be formed by cutting into the permanent seal 201 along the first long edge 308(a), 308(b). The multi-compartment container 100 can otherwise be formed using the same seals (e.g., breakable seals 102, permanent seals 201, cross seals 104, and opening seals 106) used when the multi-compartment container 100 is formed from the first layer 300 and the second layer 302.

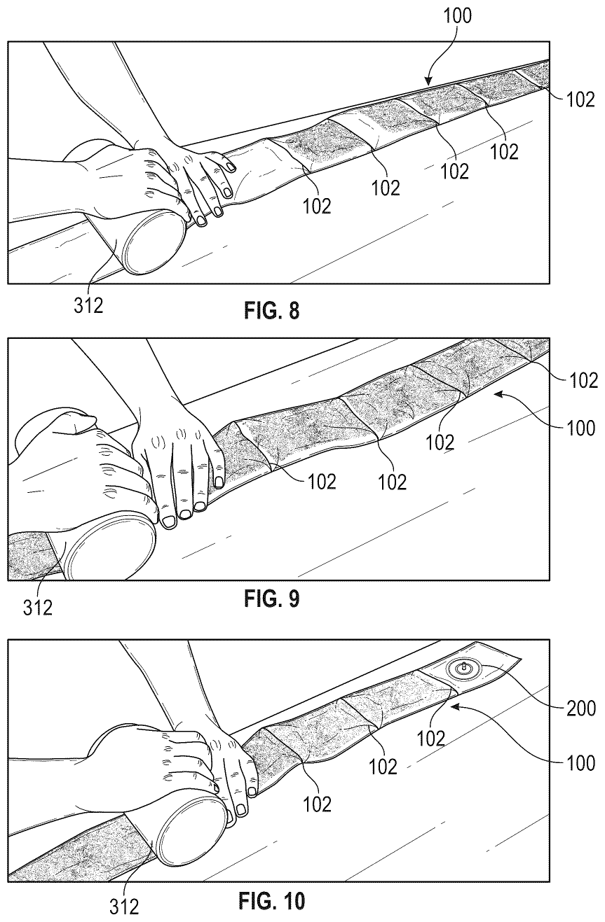

In some examples, as illustrated in FIGS. 2 and 6-7, the multi-compartment container 100 can include a terminal chamber 101 of the plurality of chambers 101, 103, 105, 107. The terminal chamber 101 can be defined by at least the first short edge seal 200(a) or the second short edge seal 200(b). In some examples, the terminal chamber 101 is the first or last chamber of the multi-compartment container 100. In some examples, the terminal chamber 101 can include an ingredient 110. In other examples, the terminal chamber 101 can be an empty chamber (e.g., not filled with an ingredient 110).

In some examples, the terminal chamber 101 can include a means for introducing and/or expelling liquid from the multi-compartment container 100. The terminal chamber 101 can be referred to as a fitment chamber. For example, the terminal chamber 101 can include a fitment 202, as illustrated, for example, in FIGS. 2 and 6-7. The fitment 202 can be configured to allow materials (e.g., fluid) to flow into and/or out of the terminal chamber 101. For example, the fitment 202 can allow for the injection of a diluent into the terminal chamber 101. In some examples, the fitment 202 can be operable to receive and/or expel a fluid.

In some examples, the fitment 202 can include a fitment coupling mechanism 203. In some examples, the fitment coupling mechanism 203 can be operable to removably couple to a device 205 (e.g., a liquid dispenser and/or administration device). For example, the fitment coupling mechanism 203 can be operable to provide a liquid tight connection with the device 205 (e.g., liquid dispenser and/or administration device), such that liquid can be provided to the terminal chamber 101. In some examples, the fitment coupling mechanism 203 can include a Luer lock, a hose bard, interface port, needle sites, or another type of coupling mechanism. In some examples, the device 205 (e.g., liquid dispenser and/or administration device) can include a syringe, a hose attached to a pump (e.g., peristaltic pump) and reservoir, or another type of liquid dispenser to provide liquid to the terminal chamber 101. In some examples, the fitment coupling mechanism 203 can further be configured to removably couple to an administration device. For example, the fitment coupling mechanism 203 can removably couple to an administration device that is operable to remove the contents of the multi-compartment container 100 from the terminal chamber 101. The administration device can include a syringe, a vial filling mechanism, or any other type of device configured to remove the contents of the multi-compartment container 100 from the terminal chamber 101.

Although only one fitment 202 is shown, it will be appreciated that multiple fitments 202 can be included. In some examples, each chamber of the plurality of chambers 101, 103, 105, 107 can include a fitment 202. In some examples, some of the chambers of the plurality of chambers 101, 103, 105, 107 can include a fitment 202, while other chambers may not include a fitment 202. The location and number of the fitments 202 can be determined based on the need for specific fluids in the formulation. For example, it may be beneficial to add a fluid to certain ingredients 110 in certain chambers of the plurality of chambers 101, 103, 105, 107 in a specific order. The fitments 202 can be located such that a desired fluid injection order can be accomplished.

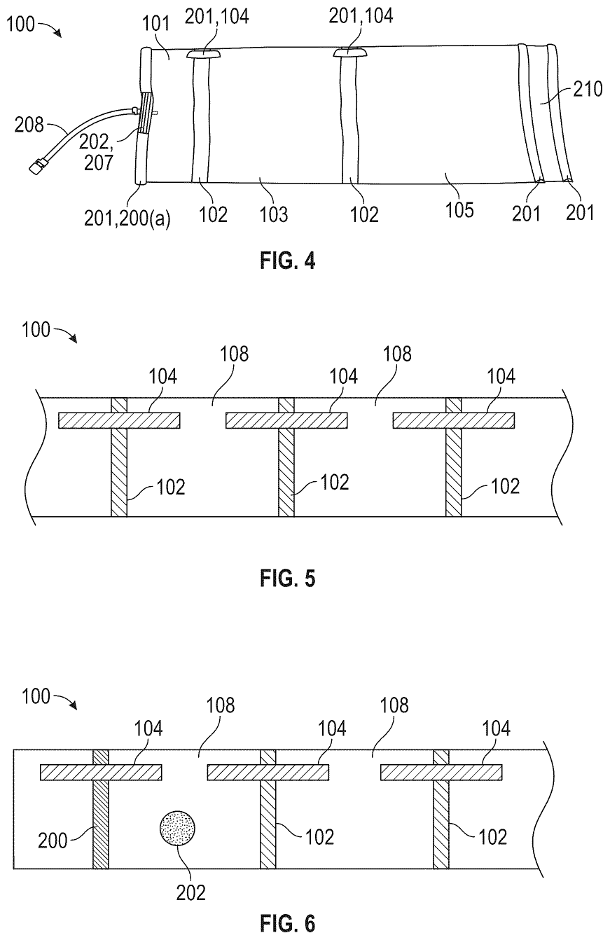

As illustrated in FIG. 4, the fitment 202 can be housed within a permanent seal 201. For example, the fitment 202 can be housed within the short edge seal 200(a). In some examples, the fitment 202 can include a boat port 207. The boat port 207 can be operable to couple to a tube 208. The boat port 207 can be sealed within the permanent seal 201 such that the terminal chamber 101 remains sealed from the external environment. In some examples, the tube 208 can be both an inlet tube and an outlet tube. For example, the tube 208 can be operable to couple to the device 205 (e.g., liquid dispenser and/or administration device). In this manner, the tube 208 can be operable to allow fluid to flow into the terminal chamber 101 when coupled to the device 205. Similarly, the tube 208 can be operable to allow fluid to be removed from the terminal chamber 101 when coupled to the device 205. In some examples, the tube 208 can include a valve operable to control fluid flow thereacross. The valve can have an open state configured to allow fluid flow through the tube 208. The valve can have a closed state configured to prevent fluid flow through the tube 208.

In some examples, the boat port 207 can be operable to couple to multiple tubes. For example, the boat port 207 can include an inlet port operable to couple to an inlet tube and an outlet port operable to couple to an outlet tube.

In some examples, as illustrated in FIG. 4, the multi-compartment container 100 can include a hanger compartment 210. The hanger compartment can be a compartment between two permanent seals 201. The hanger compartment 210 can be operable to secure a hanger therein. For example, the multi-compartment container 100 can be hung by receiving a hanger in the hanger compartment 210. In some examples, when the multi-compartment container 100 is hung, the formulation formed in the multi-compartment container 100 can be subject to the force of gravity, thereby providing easier removal of the formulation from the multi-compartment container 100 (e.g., a valve in the tube 208 can be open such that gravity forces the formulation out of the multi-compartment container 100). In this manner, the hanger compartment 210 can allow for the multi-compartment container 100 to be utilized similar to an IV bag. In some examples, the hanger compartment 210 can allow the multi-compartment container 100 to be attached to a scale. For example, the hanger compartment 210 can be operable to receive a hanger attached to a scale, such that the multi-compartment container 100 can be weighed by the scale.

In some examples, each chamber of the plurality of chambers 101, 103, 105, 107 can include an identifier 206. For example, each chamber of the plurality of chambers 101, 103, 105, 107 can include an identifier 206 that identifies the specific contents (e.g., ingredients 110) within the specific chamber. In some examples, the identifier 206 can include a printed tag, an RFID card, a QR code, a barcode, and/or another type of identifier for identifying the specific contents of the chamber. In some examples, the multi-compartment container 100 can include a single identifier 206. The single identifier can provide information related to the drug to be formulated. In some examples, the identifier 206 can further provide instructions for formulating the drug (e.g., amount and type of liquid to add, order to break the breakable seals 102, mixing instructions, etc.).

Once the plurality of chambers 101, 103, 105, 107 have been filled with the at least one ingredient 110 and the plurality of permanent seals 201 have fully sealed the exterior of the multi-compartment container 100, the multi-compartment container 100 is ready for use. In some examples, when the permanent seals 201 are not included, the multi-compartment container 100 is ready for use once the ingredients 110 are contained within the plurality of chambers 101, 103, 105, 107. In some examples, not all of the plurality of chambers 101, 103, 105, 107 are filled with at least one ingredient 110. For example, one or more of the plurality of chambers 101, 103, 105, 107 can be empty to provide sufficient space for mixing of the ingredients or to provide a chamber for receiving an ingredient 110 via the fitment 202.

The multi-compartment container 100 further provides a sterilized and decontaminated drug compounding device. For example, once the ingredients 110 are filled in the chambers 101, 103, 105, 107 and the permanent seals 201 are finalized (e.g., plurality of opening seals 106), the ingredients 110 remain sealed within the multi-compartment container 100. The multi-compartment container 100 is sealed from the external environment and the ingredients 110 can only be taken out once the breakable seals 102 are broken, thereby placing the ingredients 110 in communication with the fitment 202.

In some examples, the ingredients 110 in the plurality of chambers 101, 103, 105, 107 can be arranged in a specific (e.g., sequential) order (e.g., order of addition for compounding a drug). In this manner, the multi-compartment container 100 is programmable (e.g., has a specified order of addition depending on the formulation to be formed). For example, in drug compounding, it can often be desirable to mix certain ingredients 110 first before introducing additional ingredients 110 to the formulation later. In some examples, when filling the plurality of chambers 101, 103, 105, 107, a specific ingredient mixing order is used. For example, if a first ingredient 111 is to be mixed with a second ingredient 112 first, the first ingredient 111 is placed in the first chamber (e.g., terminal chamber 101 or chamber 103 if the terminal chamber 101 is empty) and the second ingredient 112 is placed in the second chamber (e.g., chamber 103 or chamber 105 if the terminal chamber 101 is empty). An ingredient mixing order can be used to determine the order of ingredient filling through the entirety of the plurality of chambers 101, 103, 105, 107.

In some examples, the specific (e.g., sequential) order (e.g., order of addition for compounding a drug) is important for formulating the drug. In some examples, the sequential order of ingredient mixing allows for an expedited mixing process by allowing certain ingredients 110 to mix together first. For example, some ingredients 110 can dissolve faster at certain pH values. For example, a first ingredient 111 and a second ingredient 112 can mix together faster at a certain pH value of level. A third ingredient 113 can then be used to lower the pH value to a desired level for administration to a patient. It will be appreciated that other factors can be considered in the sequential order of ingredient mixing. For example, factors such as solubility, pH, mixing reaction times, order of addition of the ingredients 112 for forming the formulation, osmolarity (e.g., concentration of certain ingredients 112 within the formulation), and other factors can guide the filling of the ingredients in the plurality of chambers 101, 103, 105, 107.

In some examples, the sequential mixing order of the plurality of chambers 101, 103, 105, 107 reduces a knowledge burden of a user. For example, in typical drug formulation processes, a user must determine a correct mixing order for ingredients to prepare a formulation. The multi-compartment container 100 eliminates the knowledge burden on the end user. For example, the ingredients 110 are filled into the plurality of chambers 101, 103, 105, 107 during manufacturing of the multi-compartment container 100. The multi-compartment container 100 can then be provided to a location where the multi-compartment container 100 is to be used by an end user to prepare a formulation. Instead of having to determine a mixing order, the end user can simply begin by breaking the first breakable seal 102 to mix the first ingredient 111 and the second ingredient 112. Then the user can break the second breakable seal 102 to mix the mixture of the first ingredient 111 and the second ingredient 112 with the third ingredient 113. In this manner, the knowledge burden on the end user is completely eliminated.

In some examples, once a user is ready to formulate a drug with the multi-compartment container 100, the user can begin by breaking one or more of the breakable seals 102. In some examples, when ordered mixing is required, the user can break the breakable seals 102 in a specific order such that the desired ingredient 110 is added to the mixture and sufficiently combined before adding the next ingredient 110. In some examples, the plurality of breakable seals 102 can be peelable seals. For example, a user can peel the plurality of breakable seals 102 off, thereby opening adjacent chambers of the plurality of chambers 101, 103, 105, 107 up to one another and allowing for the mixing of the respective ingredients 110. In some examples, formulating the drug can include placing the multi-compartment container 100 under a laminar flow hood.

In some examples, the plurality of breakable seals 102 can be broken by applying pressure to the multi-compartment container 100. For example, the user can press down on one or more of the chambers of the plurality of chambers 101, 103, 105, 107 adjacent to the breakable seal 102 to be broken, thereby causing the breakable seal 102 at the edge of the chamber being provided the force to burst.

In some examples, a tool can be used to break the plurality of breakable seals. FIGS. 8-10 illustrate the use of a roller 312 to break the plurality of breakable seals 102. For example, a user can roll the roller 312 along the multi-compartment container 100 such that the plurality of breakable seals 102 break as the pressure builds inside of each of the plurality of chambers 101, 103, 105, 107 in sequential order. In some examples, the roller 312 can further influence mixing of the ingredients 110 in the chambers 101, 103, 105, 107 as the plurality of breakable seals 102 break. For example, as the roller 312 translates along the multi-compartment container 100 the ingredients 110 can be prevented from flowing back beyond the roller 312, thereby forcing the ingredients 110 to mix in front of the roller 312.

In some examples, the roller 312 can be automated. For example, the roller 312 can be coupled to a mixing system and the mixing system can be operable to translate the roller 312 along the multi-compartment container. In some examples, the mixing system can further include a rocker plate, shaker, or vibration means to mix the contents of the multi-compartment container 100.

In some examples, before breaking the plurality of breakable seals 102 a liquid can be added to the terminal chamber 101 via the fitment 202 described herein. The plurality of breakable seals 102 can then be broken and the contents can be mixed as described herein.

In some examples, adding a liquid to terminal chamber 101 can be operable to break the plurality of breakable seals 102. The liquid added to the chamber 101 can provide a pressure within the terminal chamber 101 sufficient to break the breakable seal 102 defining the terminal chamber 101 (e.g., separate the two layers forming the seal 102 with sufficient force). For example, a certain volume of liquid can be operable to build a sufficient pressure to break the first breakable seal 102. Additional liquid can be added, thereby building further pressure, and the next breakable seal (e.g., breakable seal 102 between chamber 103 and chamber 105) can be broken by the pressure build up. In this manner, the remaining breakable seals 102 can also be broken, thereby allowing for the simple injection of liquid to break the breakable seals 102. In some examples, the breakable seals 102 have a pressure rating such that a certain amount of liquid volume is needed to break each breakable seal 102. In this manner, the breakable seals 102, and associated liquid volume, can also be part of the sequential mixing order described herein. For example, a first volume of liquid can be added to the terminal chamber 101 to break the first breakable seal (e.g., breakable seal between chamber 103 and chamber 105). The first ingredient 111 and the second ingredient 112 can then be mixed (e.g., via any of the mixing methods described herein or simply by the flow of liquid). Then a second volume of liquid can be added to the terminal chamber, thereby building sufficient pressure to break the next breakable seal (e.g., breakable seal 102 between chamber 105 and chamber 107). In some examples, the volume of water necessary for each mixing stage is provided to the user via instructions provided with the multi-compartment container. In this manner, sequential mixing via known liquid injection volumes can be achieved.

In some examples, the breakable seals 102 can burst and/or pull apart when a sufficient pressure is added to an adjacent chamber. For example, injecting a liquid volume into a chamber adjacent to a breakable seal 102 can provide sufficient pressure to cause the breakable seal 102 to burst and/or pull apart, thereby opening the two chambers separated by the breakable seal 102 to each other. For example, the breakable seals 102 can be formed to have a pre-defined burst pressure. The pre-defined burst pressure can be determined based on a volume of liquid, and corresponding pressure, used for each mixing stage of the formulation.

In some examples, the breakable seals 102 can be formed of interlocking portions (e.g., ridges and grooves). The interlocking portions can be operable to pull apart when a sufficient pressure is provided to a chamber adjacent to the breakable seal 102. For example, when a certain amount of liquid is injected into a chamber adjacent to a breakable seal 102, the interlocking portions of the breakable seal 102 can pull apart, thereby opening the two adjacent chambers to one another.

In some examples, the breakable seals 102 can be soluble. For example, when a liquid comes into contact with a breakable seal 102 the breakable seal can be dissolved by the liquid, thereby breaking the breakable seal.

In some examples, liquid injection can be automated. For example, a liquid dispenser can be operable to automatically begin a mixing procedure. The liquid dispenser can be configured to provide a first volume of liquid to the terminal chamber 101 to create pressure sufficient to break a first breakable seal 102. The liquid dispenser can then provide a mixing period whereby the liquid is allowed to settle. The liquid dispenser can then provide a second volume of liquid to the terminal chamber to create pressure sufficient to break a second breakable seal 102. This process can be repeated for all of the breakable seals 102 until the desired formulation is formed.

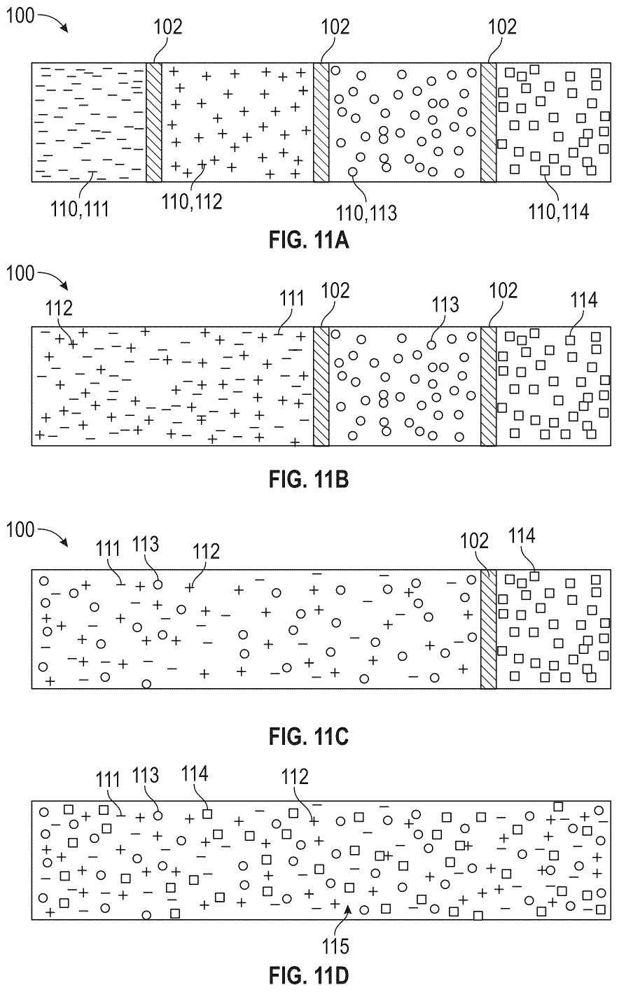

FIGS. 11A-11D illustrate a sequential mixing process for the multi-compartment container 100. FIG. 11A illustrates the first chamber 101 filled with a first ingredient 111, the second chamber 103 filled with a second ingredient 112, the third chamber 105 filled with a third ingredient 113, and the fourth chamber 107 can be filled with a fourth ingredient 114. In some examples, the first ingredient 111 can be a liquid ingredient 110 filled via the fitment 202 described herein. The breakable seals 102 can be broken in a sequential order to allow for ordered mixing of ingredients 110.

FIG. 11B illustrates the first ingredient 111 mixing with the second ingredient 112. For example, the breakable seal 102 between the first chamber 101 and the second chamber 103 can be broken, thereby allowing the first ingredient 111 to mix with the second ingredient 112. In some examples, when the breakable seal 102 between the first chamber 101 and the second chamber 103 is broken, a first larger chamber 117 is formed. The first larger chamber 117 can include the combined volume of the first chamber 101 and the second chamber 103. In some examples, the breakable seal 102 between the first chamber 101 and the second chamber 103 can be broken using any of the methods for breaking breakable seals 102 described herein. For example, the breakable seal 102 between the first chamber 101 and the second chamber 103 can be broken by pressure provided by injection of a liquid into the first chamber 101 (e.g., via the fitment 202 and the device 205). The breakable seal 102 between the first chamber 101 and second chamber 103 can be broken by peeling off a peelable seal. The breakable seal 102 between the first chamber 101 and the second chamber 103 can be broken by the roller 312. The breakable seal 102 between the first chamber 101 and the second chamber 103 can be broken by a user pressing down on the first chamber 101, thereby providing sufficient pressure to break the breakable seal 102.

In some examples, once the breakable seal 102 between the first chamber 101 and the second chamber 103 is broken, a mixing step can be conducted. In some examples, the mixing step can include placing the multi-compartment container 100 in or on a mixing device (e.g., a device that rotates the multi-compartment container 100, a rocker to shake the multi-compartment container 100, a vibration mechanism to vibrate the multi-compartment container 100, or another mechanical mixing device) to mix the first ingredient 111 and the second ingredient 112. In some examples, the user can manually mix the first ingredient 111 and the second ingredient 112 by manually shaking, rotating, or otherwise moving the multi-compartment container 100. In some examples, a separate mixing step is not necessary as the first ingredient 111 and the second ingredient 112 can flow into one another once the breakable seal 102 separating the first chamber 101 and the second chamber 103 breaks.

FIG. 11C illustrates the third ingredient 113 mixing with the first ingredient 111 and the second ingredient 112. For example, the breakable seal 102 between the third chamber 105 and the first larger chamber 117 (e.g., first larger chamber 117 includes the volume of first chamber 101 and second chamber 103) can be broken, thereby allowing the third ingredient 113 to mix with the first ingredient 111 and the second ingredient 112. In some examples, when the breakable seal 102 between the third chamber 105 and the first larger chamber 117 is broken, a second larger chamber 118 is formed. The second larger chamber 118 can include the combined volume of the first chamber 101, the second chamber 103, and the third chamber 105. In some examples, the breakable seal 102 between the third chamber 105 and the first larger chamber 117 can be broken using any of the methods for breaking breakable seals 102 described herein. For example, the breakable seal 102 between the third chamber 105 and the first larger chamber 117 can be broken by pressure provided by injection of additional liquid into the first larger chamber 117 (e.g., via the fitment 202 and the device 205 coupled to the first chamber 101). The breakable seal 102 between the first larger chamber 117 and the third chamber 105 can be broken by peeling off a peelable seal. The breakable seal 102 between the first larger chamber 117 and the third chamber 105 can be broken by the roller 312. The breakable seal 102 between the first larger chamber 117 and the third chamber 105 can be broken by a user pressing down on the first larger chamber 117, thereby providing sufficient pressure to break the breakable seal 102.

In some examples, once the breakable seal 102 between the first larger chamber 117 and the third chamber 105 is broken, a mixing step can be conducted. In some examples, the mixing step can include placing the multi-compartment container 100 in or on a mixing device (e.g., a device that rotates the multi-compartment container 100, a rocker to shake the multi-compartment container 100, a vibration mechanism to vibrate the multi-compartment container 100, or another mechanical mixing device) to mix the first ingredient 111, the second ingredient 112, and the third ingredient 113. In some examples, the user can manually mix the first ingredient 111, the second ingredient 112, and the third ingredient 113 by manually shaking, rotating, or otherwise moving the multi-compartment container 100. In some examples, a separate mixing step is not necessary as the first ingredient 111, the second ingredient 112, and the third ingredient 113 can flow into one another once the breakable seal 102 separating the first larger chamber 117 and the third chamber 105 breaks.

FIG. 11D illustrates the first ingredient 111, second ingredient 112, third ingredient 113, and fourth ingredient 114 mixing together. For example, the breakable seal 102 between the second larger chamber 118 and the fourth chamber 107 can be broken, thereby allowing the first ingredient 111, second ingredient 112, and third ingredient 113 to mix with the fourth ingredient 114. In some examples, when the breakable seal 102 between the second larger chamber 118 and the fourth chamber 107 is broken, a third larger chamber 119 is formed. The third larger chamber 119 can include the combined volume of the first chamber 101, the second chamber 103, the third chamber 105, and the fourth chamber 107. In some examples, the breakable seal 102 between the second larger chamber 118 and the fourth chamber 107 can be broken using any of the methods for breaking the breaking the breakable seals 102 described herein. For example, the breakable seal 102 between the second larger chamber 118 and the fourth chamber 107 can be broken by pressure provided by injection of additional liquid into the second larger chamber 118 (e.g., via the fitment 202 and the device 205 coupled to the first chamber 101). The breakable seal 102 between the second larger chamber 118 and the fourth chamber 107 can be broken by peeling off a peelable seal. The breakable seal 102 between the second larger chamber 118 and the fourth chamber 107 can be broken by the roller 312. The breakable seal between the second larger chamber 118 and the fourth chamber 107 can be broken by a user pressing down on the second larger chamber 118, thereby providing sufficient pressure to break the breakable seal 102.

In some examples, once the breakable seal 102 between the second larger chamber 118 and the fourth chamber 107 is broken, a mixing step can be conducted. In some examples, the mixing step can include placing the multi-compartment container 100 in or on a mixing device (e.g., a device that rotates the multi-compartment container 100, a rocker to shake the multi-compartment container 100, a vibration mechanism to vibrate the multi-compartment container 100, or another mechanical mixing device) to mix the first ingredient 111, the second ingredient 112, the third ingredient 113, and the fourth ingredient 114. In some examples, the user can manually mix the first ingredient 111, the second ingredient 112, the third ingredient 113, and the fourth ingredient 114 by manually shaking, rotating, or otherwise moving the multi-compartment container 100. In some examples, a separate mixing step is not necessary as the first ingredient 111, second ingredient 112, third ingredient 113, and fourth ingredient 114 can flow into one another once the breakable seal 102 separating the second larger chamber 118 and the fourth chamber 107 breaks.

Once the first ingredient 111, second ingredient 112, third ingredient 113, and fourth ingredient 114 are mixed, the drug 115 has been formulated from the ingredients 110. In some examples, once the drug 115 is formulated, a user can remove the drug from the multi-compartment container 100 via the fitment 202 and the device 205. The drug 115 can then be administered to a patient via the device 205 (e.g., administration device). Since the ingredients 110 are contained within the multi-compartment container 100 at all times, and the ingredients 110 can be filled into the chambers 101, 103, 105, 107 in a sterile manner, the formulated drug to be administered can be a sterilized drug 115.

Although four ingredients (e.g., first ingredient 111, second ingredient 112, third ingredient 113, and fourth ingredient 114) are shown in FIGS. 11A-11D, it will be appreciated that any number of ingredients 110, chambers 101, 103, 105, 107, and breakable seals 102 can be used depending on the number of ingredients necessary to form the drug 115.

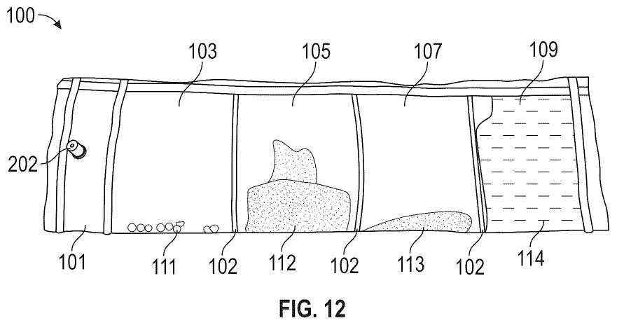

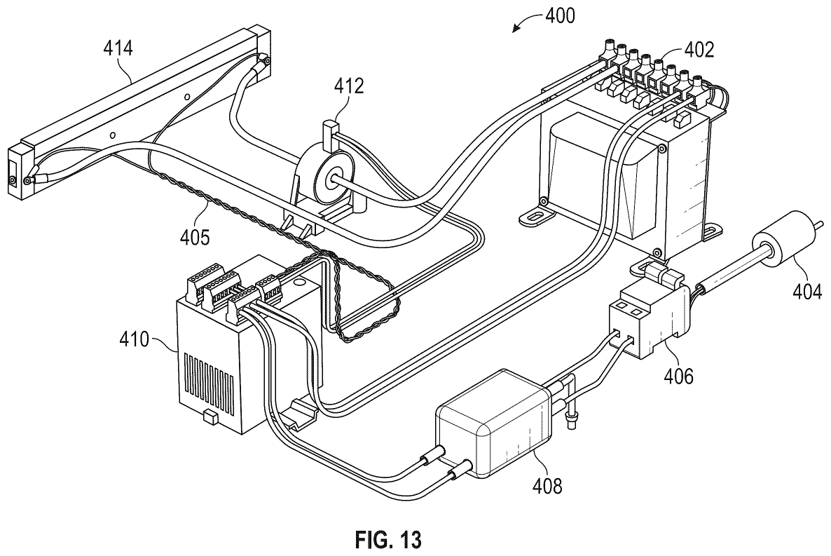

FIG. 12 illustrates a multi-compartment container 100 filled with ingredients 110 in a sequential mixing order. For example, the first ingredient 111 can be sodium hydroxide. The second ingredient 112 can be furosemide, which is the active pharmaceutical ingredient. The third ingredient 113 can be sodium chloride. The fourth ingredient 114 can be hydrochloric acid. First, a first volume of water can be added to the terminal chamber 101 via the fitment 202. The first volume of water can provide a sufficient pressure within the terminal chamber 101 to break the first breakable seal (e.g., breakable seal 102 between terminal chamber 101 and chamber 103). The first volume of water and sodium hydroxide (first ingredient 111) can mix to form a first mixture. The first mixture of water and sodium hydroxide (first ingredient 111) can form a liquid having a high pH level. A second volume of water can then be added to the first mixture via the fitment 202 forming a second mixture. The second volume of water can provide a sufficient pressure to break the second breakable seal (e.g., breakable seal 102 between chamber 103 and chamber 105). Due to the sodium hydroxide, the second mixture (first volume of water, second volume of water, and sodium hydroxide) can have an elevated pH. The second ingredient 112, furosemide, can dissolve faster in elevated pH solutions. In this manner, mixing the water, sodium hydroxide, and furosemide first expedites the dissolution of furosemide due to the elevated pH mixture the furosemide is dissolved in. A third volume of water can then be added via the fitment. The third volume of water can provide a sufficient pressure to break the third breakable seal (e.g., breakable seal 102 between chamber 105 and chamber 107). In this manner, the sodium chloride (third ingredient 113) can be added to the mixture. Sodium chloride can provide isotonicity to the formulation (e.g., sodium chloride matches the concentration of solutes in the formulation to that of bodily fluids, making it suitable for injection). A fourth volume of water can then be added via the fitment 202. The fourth volume of water can provide a sufficient pressure to break the fourth breakable seal (e.g., breakable seal 102 between chamber 107 and chamber 109). In this manner, the hydrochloric acid (fourth ingredient 114) can be added to the mixture. The hydrochloric acid can lower the pH level of the formulation, thereby making the formulation safe for administration to a patient.

While the aforementioned disclosure discusses adding fluid each time a chamber 101, 103, 105, 107 is accessed by breaking a seal 102, in some examples, every step may not require additional fluid. Accordingly, in some examples, the ingredients 110 may mix without adding additional fluid, and then the subsequent breakable seal 102 can be broken.

As described with reference to FIG. 12, the sequential, pre-defined mixing order of ingredients 110 within the multi-compartment container can provide an efficient and easy formulation preparation process. A user is not required to understand a proper mixing order, as the mixing order is pre-defined by the multi-compartment container 100. Further, the ingredients 110 are kept separate prior to use, thereby extending shelf-life.

Although the multi-compartment container 100 is described herein as being used to formulate a drug, it will be appreciated that the multi-compartment container 100 can be used for other purposes. For example, the multi-compartment container 100 can be used to compound other materials such as food products, cosmetics, pigmentation, biological production, and fuel mixture.

Further provided herein is a system 400 for forming the multi-compartment container 100. The system 400 can be operable to form the multi-compartment container 100 by making the plurality of permanent seals 201 and the plurality of breakable seals 102 described herein.

FIG. 13 illustrates the system 400 for forming the multi-compartment container 100. The system 400 can include a heat seal assembly 401 and a workbench 403. The heat seal assembly 401 can include a heat seal press 414. The heat seal press 414 can be operable to be heated to the necessary temperature to form the plurality of permanent seals 201 and the breakable seals 102 described herein. In some examples, the heat seal press 414 can be a toss jaw bar with a heat seal band.

In some examples, the heat seal assembly 401 can include various components for controlling the operation of the seal press 414. For example, the heat seal press 414 can include a power supply 404. The power supply 404 can be operable to provide power to the heat seal assembly 401.

In some examples, the heat seal assembly 401 can further include a circuit breaker 406. In some examples, the circuit breaker 406 can include a plurality of fuses. In some examples, the circuit breaker 406 can ensure that the power supply 404 does not draw an excess amount of power to the heat seal assembly 401. For example, the circuit breaker 406 can ensure that the power consumption of the heat seal assembly 401 maintains a safe power consumption level.

The heat seal assembly can further include a line filter 408, a controller 410, an impulse transformer 402, a current transformer 412, and a voltage measurement wire 405. The controller 410 can be operable to control the operation of the heat seal press 414. For example, the controller 410 can be operable to control the impulse transformer 402 and the current transformer 412 such that the heat seal press 414 reaches a desired temperature. Further, the controller 410 can be operable to receive voltage measurements from the voltage measurement wire 405 to ensure that the heat seal assembly 401 is functioning properly. In some examples, the controller 410 can be in communication with a graphical user interface. The graphical user interface can be operable to receive inputs from a user to set a temperature of the heat seal press 414 and/or an input to close the jaws of the heat seal press 414 on the first layer 300 and second layer 302.

In some examples, the heat seal press 414 can have multiple temperature settings. In some examples, the heat seal press 414 can have a first temperature setting for forming the plurality of permanent seals 201 of the multi-compartment container 100. In some examples, the heat seal press 414 can have a second temperature setting for forming the plurality of breakable seals 102. In some examples, the second temperature setting has a lower temperature than the first temperature setting (e.g., the breakable seals 102 are formed with a lower temperature and therefore have lower strength than the permanent seals 201).

In some examples, the heat seal press 414 includes jaws. The jaws can be pneumatically actuated. For example, the first layer 300 and the second layer 302 can be properly aligned within the jaws to form any of the plurality of permanent seals 201 and/or breakable seals 102 described herein. The jaws are first heated to the desired temperature for the type of seal (e.g., permanent seal 201 or breakable seal 102). Once the jaws are heated, the jaws of the heat seal press 414 are pneumatically actuated to press down on the first layer 300 and the second layer 302, thereby forming the seal. In some examples, the jaws can remain in place for a period of time exerting a pressure on the seal to form a stronger seal. In some examples, the jaws are cooled while still engaged to the first layer 300 and the second layer 302. In some examples, the jaws do not disengage until a cool down temperature is reached and/or a cool down time period has passed.

In some examples, the temperature, duration of engagement, and cool down time determine the type of seal formed by the jaws of the heat seal press 414. In this manner, a plurality of permanent seals and a plurality of breakable seals 102 can be formed by adjusting the parameters of the jaws of the heat seal press 414.

In some examples, the system 400 can further include a cooling mechanism for cooling the permanent seals 201 and the breakable seals 102. For example, the cooling mechanism can include cooling jaws, a fan, filters, and/or a cooling liquid dispenser to provide cooling to the permanent seals 201 and the breakable seals 102.

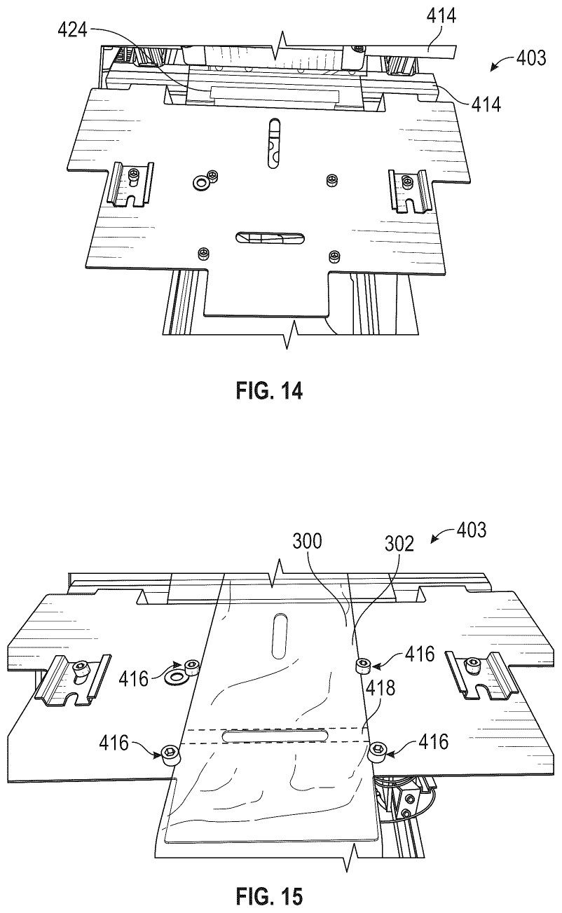

FIGS. 14-16 illustrate a workbench 403 of the system 400. The workbench 403 can be operable to aid in aligning the first layer 300 and the second layer 302 when forming the multi-compartment container 100. The workbench 403 can further include the heat press area 424. The heat press area 424 can include the heat seal press 414. In some examples, when the heat seal press 414 has two jaws that open and close, the heat press area 424 can be an opening where the jaws of the heat seal press 414 can open and close.

In some examples, the workbench 403 can include one or more alignment features. In some examples, the one or more alignment features can include one or more alignment slots 418, 420. The one or more alignment slots 418, 420 aid in properly orienting the first layer 300 and the second layer 302 for the permanent seals 201 and the breakable seals 102. The one or more alignment features can further include one or more guides 416. In some examples, the one or more guides 416 can be operable to secure the first layer 300 and the second layer 302 in place on the workbench 403. In some examples, the one or more guides 416 can include nuts.

FIG. 15 illustrates the first layer 300 and the second layer 302 positioned on the workbench 403 for forming the plurality of breakable seals 102. An alignment slot 418 can be used to properly align the first layer 300 and the second layer 302 for a breakable seal 102. For example, a previous breakable seal 102 can be aligned with the alignment slot 418. The one or more guides 416 can be operable to properly align the first layer 300 and the second layer 302 with the heat press area 424. In some examples, the one or more guides 416 can removably secure to the first layer 300 and the second layer 302 such that the first layer 300 and the second layer 302 do not move with respect to the workbench 403. For example, the one or more guides 416 can be nuts that can be rotated towards the workbench 403 to secure the first layer 300 and the second layer 302. In other examples, the one or more guides 416 can be pushed downward and snap into place to secure the first layer 300 and the second layer 302. In some examples, to release the first layer 300 and the second layer 302, the one or more guides 416 can be pushed downward again and release from the locked position.

Once the previous breakable seal 102 is aligned with the alignment slot 418 and the first layer 300 and the second layer 302 are aligned within the one or more guides 416, the heat seal press 414 can form another breakable seal 102 at the heat seal press area 424. The user can then pull the first layer 300 and the second layer 302 away from the heat press area 424 (e.g., towards the alignment slot 418). The process can be repeated until a desired number of breakable seals 102 have been formed.

While the configuration of FIG. 15 was described with reference to the breakable seals 102, it will be appreciated that the first short edge seal 200(a) and the second short edge seal 200(b) can be formed in the same manner. However, the first short edge seal 200(a) and the second short edge seal 200(b) can be permanent seals 201 and thus the heat seal press 414 provides a higher temperature for the first short edge seal 200(a) and the second short edge seal 200(b).

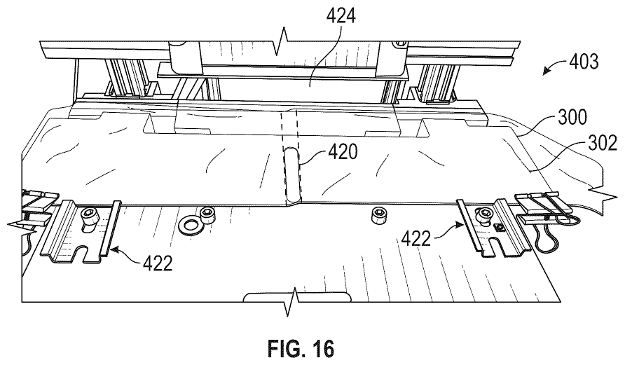

FIG. 16 illustrates the first layer 300 and the second layer 302 on the workbench 403 for forming permanent seals 201. In the example of FIG. 16, the plurality of cross seals 104 are to be formed. The workbench 403 can include alignment slot 420 for aligning the breakable seals 102. The workbench 403 can further include one or more guide rails 422 for aligning the first layer 300 and the second layer 302. A user can align a breakable seal 102 with alignment slot 420 and ensure that the first layer 300 and the second layer abut against the one or more guide rails. The heat seal press 414 can then form a cross seal 104 at the heat press area 424. Once the cross seal 104 is formed, the first layer 300 and the second layer 302 can be moved until a next breakable seal 102 aligns with the alignment slot 420, and the process can be repeated.

It will be appreciated that the long edge seal 204 can also be accomplished in the same manner. For example, the long edge seal 204 can be formed by the heat seal press by aligning the first layer 300 and the second layer 302 with the one or more guide rails 422 and actuating the heat seal press 414. This process can be repeated along an entire length of the first layer 300 and the second layer 302 until the first long edge seal 204 is formed.

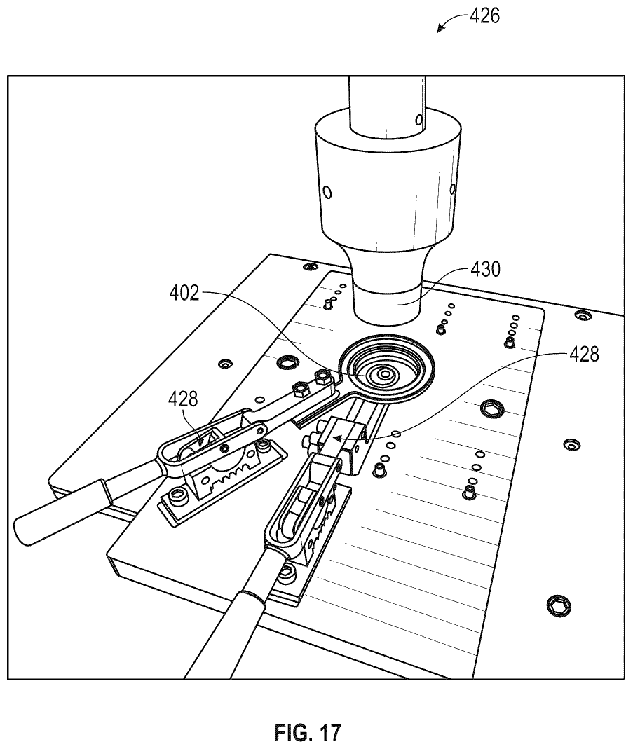

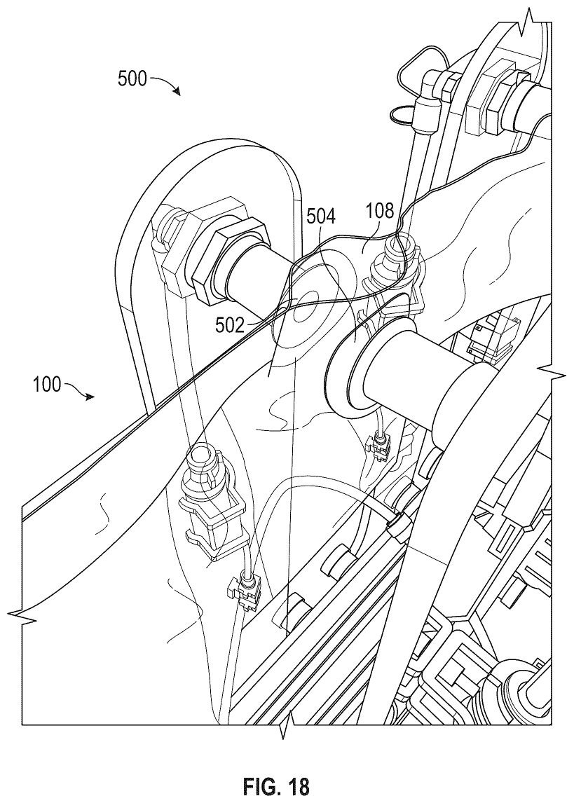

FIG. 17 illustrates a fitment manufacturing tool 426 of the system 400. The fitment manufacturing tool 426 can be operable to secure the fitment 202 to the terminal chamber 101 of the multi-compartment container 100. In some examples, the terminal chamber 101 can be held open by one or more chamber holders 502, 504 (e.g., suction cups), as illustrated in FIG. 18. While the terminal chamber 101 is being held open by the one or more chamber holders 502, 504 (e.g., suction cups for holding open the opening 108), a user can insert a support backer into the terminal chamber 101. A hole punch can then be used to punch a hole in the terminal chamber 101. The hole can be operable to receive the fitment 202.

As illustrated in FIG. 17, the fitment manufacturing tool 426 can include grippers 428 for fitment 202 in place with respect to the terminal chamber 101. An ultrasonic welder 430 can then be used to weld the fitment 202 to the terminal chamber 101.

In some examples, the system 400 can further include a printer. The printer can be operable to print the identifiers 206. For example, the printer can print the identifiers 206 directly on to the multi-compartment container 100. In some examples, the printer can print the identifiers 206 and a user can secure the identifiers 206 to the multi-compartment container 100 (e.g., via an adhesive or another method).

Further provided herein is a system for filling the multi-compartment container 100. The system can be operable to fill the plurality of chambers 101, 103, 105, 107 (or some of the plurality of chambers 101, 103, 105, 107) with at least one ingredient 110.

In some examples, the at least one ingredient 110 can include ingredients for injectable and/or intravenous medicines. In some examples, the at least one ingredient 110 can include specific active pharmaceutical ingredients (APIs) and one or more active ingredients. In some examples, the at least one ingredient 110 can include excipients. In some examples, the at least one ingredient 110 can include powders, liquids, gases, gels, tablets, solid objects, instruments, oxygen-sensitive fasteners, tools, sensors, filters, and/or catalysts.

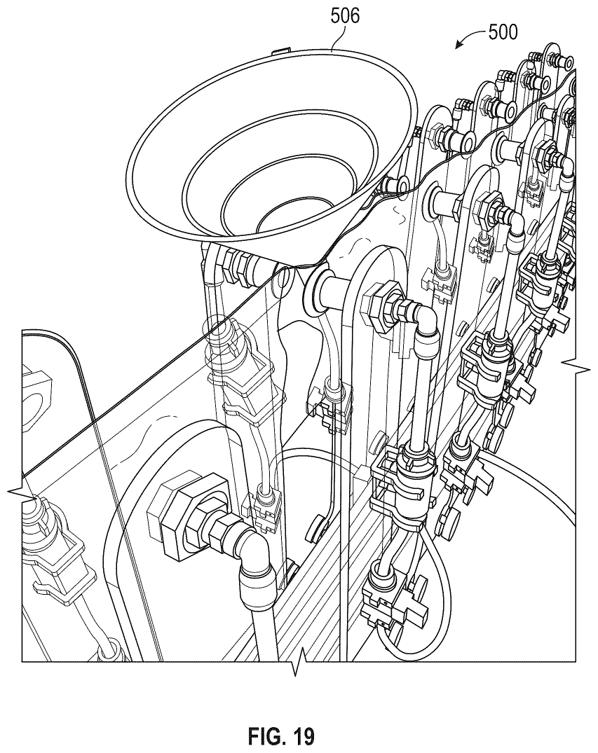

FIGS. 18-19 illustrate the system 500 for filling the multi-compartment container. As illustrated in FIG. 18, the system 500 can include one or more chamber holders 502, 504. The one or more chamber holders 502, 504 can be operable to hold open the plurality of openings 108. In some examples, the one or more chamber holders 502, 504 can include a sufficient number of chamber holders 502, 504 such that all openings of the plurality of openings 108 can be held open at the same time. In some examples, the one or more chamber holders 502, 504 can hold open one opening 108 of the plurality of openings 108 at a time and once the chamber 101, 103, 105, 107 being held open is filled, the multi-compartment container 100 can be moved such that the one or more chamber holders 502, 504 can hold open the next chamber to be filed.

In some examples, the one or more chamber holders 502, 504 can include position sensors. The position sensors can be operable to determine a location for the one or more chamber holders 502, 504 to grip on to each of the plurality of chambers 101, 103, 105, 107.

In some examples, the one or more chamber holders 502, 504 can include suction cups. For example, the suction cups can be operable to grip the exterior surface of a chamber (e.g., plurality of chambers 101, 103, 105, 107) and hold open the opening 108 for the specific chamber. In some examples, one or more chamber holders 502, 504 can include opposing suction cups such that the exterior surfaces on both sides of the chamber (e.g., exterior surface of first layer 300 and exterior surface of second layer 302) can be held open. In some examples, the suction cups can be connected to a vacuum pressure source, such that the suction cups (e.g., one or more chamber holders 502, 504) grip the exterior surface of the chamber (e.g., plurality of chambers 101, 103, 105, 107).

As illustrated in FIG. 19, the system 500 can further include an insertion mechanism 506. The insertion mechanism 506 can allow for the at least one ingredient 110 to be inserted through the opening 108 and into the chamber (e.g., of the plurality of chambers 101, 103, 105, 107). In some examples, a user can have a predefined amount of an ingredient 110 or ingredients 110 to be inserted into a specific chamber of the plurality of chambers 101, 103, 105, 107. The predefined amount can be placed into the insertion mechanism 506 and the ingredient 110 or ingredients 110 can be filled into the chamber of the plurality of chambers 101, 103, 105, 107. In some examples, the insertion mechanism 506 can include a funnel or another type of insertion mechanism operable to allow for easy filling of the chamber.

After all of the chambers of the plurality of chambers 101, 103, 105, 107 have been filled, the openings 108 can be sealed as described herein. In other examples, once a single chamber has been filled, the chamber's corresponding opening 108 is closed, and then another chamber can be filled.

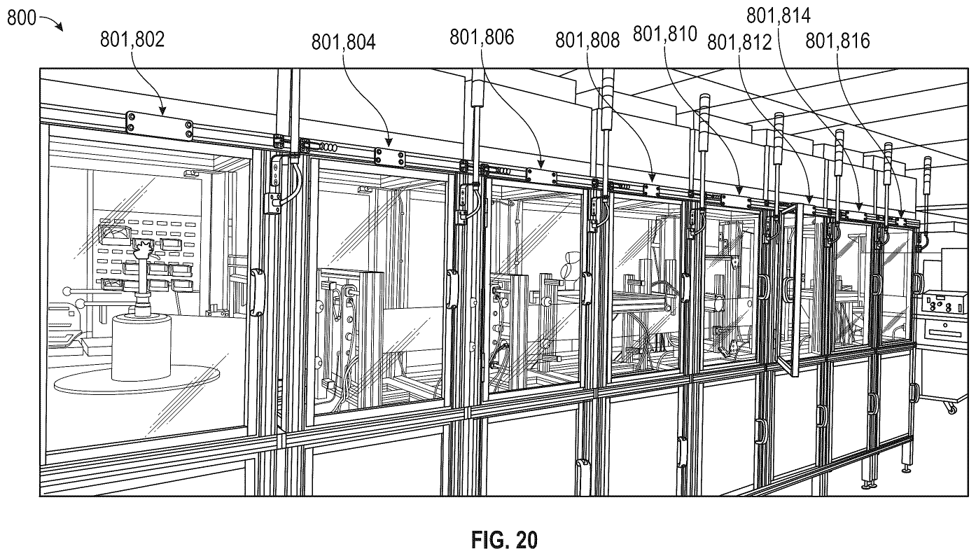

FIG. 20 illustrates an automated system 800 for manufacturing the multi-compartment container 100. The automated system 800 can include one or more components of the system 400. In some examples, the automated system 800 can be operable to manufacture and fill the multi-compartment container 100 without the need for manual user intervention. The automated system 800 can include a plurality of stations 802 operable to manufacture the multi-compartment container 100. The automated system 800 can be operable to form the various seals (e.g., breakable seals 102, permanent seals 201, cross seals 104, and opening seals 106). The automated system 800 can fill the plurality of chambers 101, 103, 105, 107 with ingredients 110. In some examples, the automated system 800 can fill the plurality of chambers 101, 103, 105, 107 with ingredients 110 in a sequential order (e.g., order of addition) such that when an end user begins a mixing process with the multi-compartment container 100 the ingredients are already in a pre-defined mixing order.

In some examples, the automated system 800 can have a controller. The controller can be operable to receive various inputs from a user to manufacture the multi-compartment container with specific features (e.g., number of chambers, volume of chambers, etc.). In some examples, the automated system can be configured to manufacture multi-compartment containers 100 of varying sizes. The controller of the automated system 800 can allow a user to customize the multi-compartment container 100 depending on the formulation to be formulated using the multi-compartment container 100.

The automated system 800 can include a plurality of stations 801 for performing various functions to manufacture the multi-compartment container 100. For example, the plurality of stations 801 can be operable to provide a flat roll tube for forming the multi-compartment container 100. The plurality of stations 801 can be operable to form permanent seals 201 (e.g., via heat seal press 414). The plurality of stations 801 can be operable to form the breakable seals 102 (e.g., via heat seal press 414). The plurality of stations 801 can be operable to cut the plurality of openings 108 in the multi-compartment container 100. The plurality of stations 801 can be operable to form the cross seals 104 (e.g., via heat seal press 414). The plurality of stations 801 can be operable to form the opening seals 106 (e.g., via heat seal press 414).

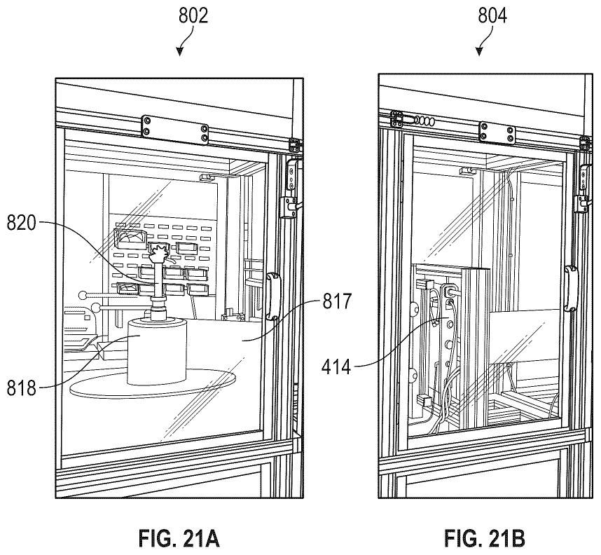

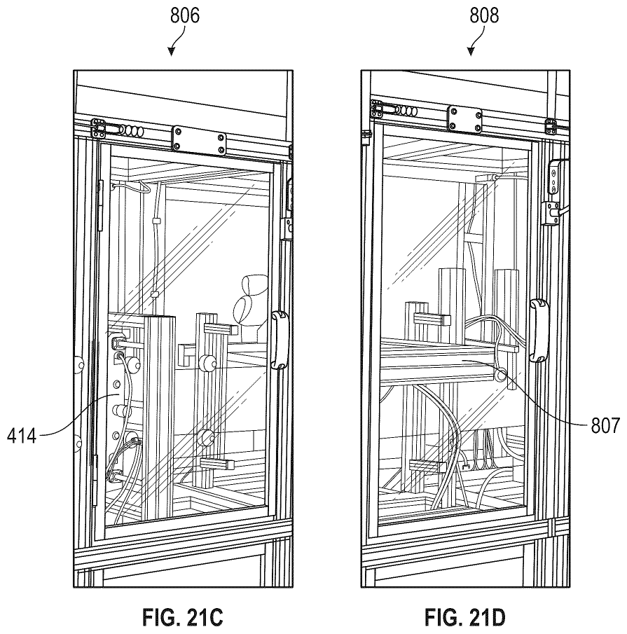

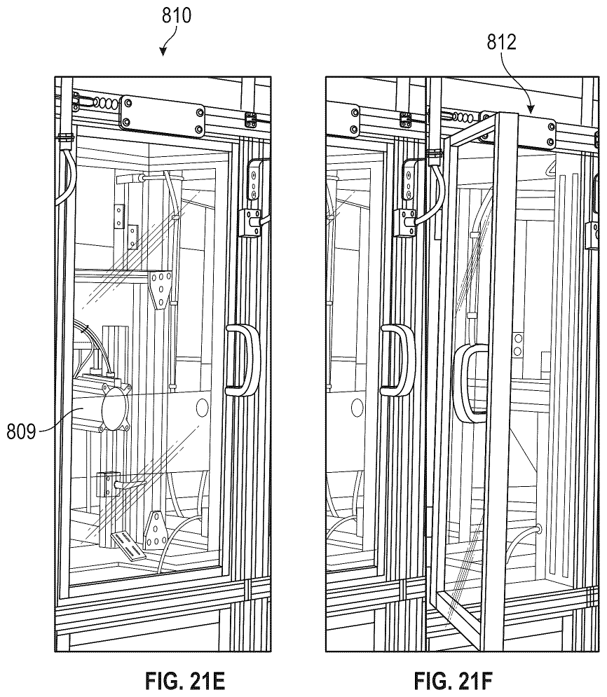

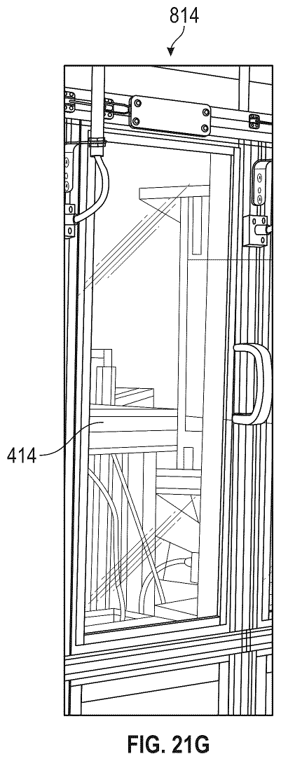

As illustrated in FIG. 21A, the automated system 800 can include a roll tube station 802. The roll tube station 802 can be operable to provide a roll tube material 817 for forming the multi-compartment container 100. In some examples, the roll tube station can include a spool 820. A roll tube 818 can be held on the spool 820 such that the roll tube 818 can unravel, thereby providing roll tube material to the plurality of stations 801 for forming the multi-compartment container 100. In some examples, the roll tube material 817 can include sealed long edges (e.g., first long edge 308(a), 308(b) and second long edge 310(a), 310(b)). For example, the sealed long edges can be sealed with a permanent seal 201. In some examples, the roll tube material 817 can include open short edges (e.g., first short edge 304(a), 304(b) and second short edge 306(a), 306(b)). In some examples, the automated system can include a gripping mechanism (not shown) operable to grip a short edge (e.g., first short edge 304(a), 304(b) or second short edge 306(a), 306(b)) of the roll tube material 817. The gripping mechanism can be operable to pull the roll tube material 817 through the plurality of stations 801. In some examples, the gripping mechanism can be operable to maintain the orientation of the roll tube material 817 in a desired orientation for manufacture of the multi-compartment container (e.g., with the long edges 308(a), 308(b), 310(a), 310(b) held longitudinally within the automated system 800 and the short edges 304(a), 304(b), 306(a), 306(b) held vertically within the automated system 800).

As illustrated in FIG. 21B, the automated system 800 can include a short edge seal station 804. The short edge seal station 804 can be operable to form the short edge seals (e.g., permanent seals 201) on the multi-compartment container 100. For example, the short edge seal station 804 can be operable to form the first short edge seal 200(a), the second short edge seal 200(b), and/or permanent seals 201 for forming the hanger compartment 210. The short edge seal station 804 can include a heat seal press 414. The heat seal press 414 can be operable to form the permanent seals 201 by heating the roll tube material 817. In some examples, the heat seal press 414 can include heated jaws. The heated jaws can be operable to compress against the roll tube material 817 and form the permanent seals 201. In some examples, the heat seal press 414 of the short edge seal station 804 can be oriented in a vertical direction.

As illustrated in FIG. 21C, the automated system 800 can include a breakable seal station 806. The breakable seal station 806 can be operable to form the breakable seals 102 on the multi-compartment container 100. For example, the breakable seal station 806 can be operable to form breakable seals 102 on the roll tube material 817, thereby forming the plurality of chambers 101, 103, 105, 107. In some examples, the breakable seal station 806 can include a heat seal press 414. The heat seal press 414 can be operable to form the breakable seals 102 by heating the roll tube material 817. In some examples, the heat seal press 414 can include heated jaws operable to compress against the roll tube material 817 at a desired location, thereby forming the breakable seals 102. In some examples, the heat seal press 414 of the breakable seal station 806 can be oriented in a vertical direction.

As illustrated in FIG. 21D, the automated system 800 can include a cross seal station 808. The cross seal station 808 can be operable to form the cross seals 104 on the multi-compartment container 100. For example, the cross seal station 808 can be operable to form the cross seals 104 on the roll tube material 817. In some examples, the cross seal station 808 can include a heat seal press 414. The heat seal press 414 can be operable to form the cross seals 104 by heating the roll tube material 817. In some examples, the heat seal press 414 can include heated jaws operable to compress against the roll tube material 817 at a desired location (e.g., across the breakable seals 102), thereby forming the cross seals 104. In some examples, the heat seal press 414 of the cross seal station 808 can be oriented in a horizontal direction.

As illustrated in FIG. 21E, the automated system 800 can include a compartment punch station 810. In some examples, the compartment punch station 810 can be operable to form the plurality of openings 108 described herein. For example, the roll tube material 817 can be pre-sealed along the first long edge 308(a), 308(b) and second long edges 310(a), 310(b). The compartment punch station 810 can be operable to punch (e.g., cut or otherwise open) each chamber of the plurality of chambers 101, 103, 105, 107, thereby forming the plurality of openings 108. In this manner, each chamber of the plurality of chambers 101, 103, 105, 107 can be opened such that an ingredient 110 can subsequently be filled into each chamber of the plurality of chambers 101, 103, 105, 107. In some examples, the compartment punch station 810 can include a cutting device 809 operable to cut into each chamber of the plurality of chambers 101, 103, 105, 107 near the first long edge 308(a), 308(b), such that an opening 108 of the plurality of openings 108 is formed near the first long edge 308(a), 308(b). In some examples, the cutting device 809 can include a hole punch operable to form the openings 108 in each chamber of the plurality of chambers 101, 103, 105, 107. In some examples, the cutting device 809 can include a knife, blade, or other cutting mechanism operable to form the openings 108 in the plurality of chambers 101, 103, 105, 107.

As illustrated in FIG. 21F, the automated system 800 can include a filling station 812. The filling station 812 can be operable to fill ingredients 110 into each chamber of the plurality of chambers 101, 103, 105, 107. In some examples, the filling station 812 can include a filling mechanism operable to fill the ingredients 110 into the plurality of chambers 101, 103, 105, 107. In some examples, the filling mechanism can include a robotic arm operable to dispense ingredients 110 into each of the plurality of chambers 101, 103, 105, 107. In some examples, the filling station 812 can include a door 813. The door 813 can be opened by a user and a user can fill the ingredients 110 into the plurality of chambers 101, 103, 105, 107 manually. In some examples, the filling station 812 can include the chamber holders 502, 504. The chamber holders 502, 504 can be operable to hold the openings 108 of the chambers 101, 103, 105, 107 open during filling.

As illustrated in FIG. 21G, the automated system 800 can include an opening seal station 814. The opening seal station 814 can be operable to form the opening seals 106. For example, after each chamber of the plurality of chambers 101, 103, 105, 107 is filled with an ingredient 110, the opening seal station 814 can be operable to form the opening seals 106, thereby closing the plurality of chambers 101, 103, 105, 107 to the external environment with the ingredients 110 contained within the plurality of chambers 101, 103, 105, 107. In some examples, the opening seal station 814 can include a heat seal press 414. The heat seal press 414 can include heated jaws operable to compress against the roll tube material 817 at the openings 108, thereby forming the opening seals 106. In some examples, the heat seal press 414 of the opening seal station 814 can be oriented in a horizontal direction.

The automated system 800 can further include a system removal station 816. The system removal station 816 can be operable to receive the multi-compartment container 100 after it has been manufactured. In some examples, the system removal station 816 can include a door. A user can remove the finished multi-compartment container 100 from the system removal station 816.

In some examples, automated system 800 can further include roll tube guiding mechanisms. For example, roll tube guiding mechanisms can be operable to guide the roll tube material 817 through the plurality of stations 801 of the automated system 800. In some examples, the roll tube guiding mechanisms can be operable to properly locate the roll tube material 817 within the system such that each station of the plurality of stations can perform a function. For example, the roll tube guiding mechanisms can be operable to hold the roll tube material 817 at a pre-selected height such that the heat seal presses 414 can form the seals (e.g., breakable seals 102, cross seals 104, permanent seals 201, and opening seals 106), form the openings 108, and fill the plurality of chambers 101, 103, 105, 107 with the ingredients 110. The roll tube guide mechanisms can be operable to guide the motion of the roll tube material as it is pulled through the plurality of stations 801 via the gripping mechanism.

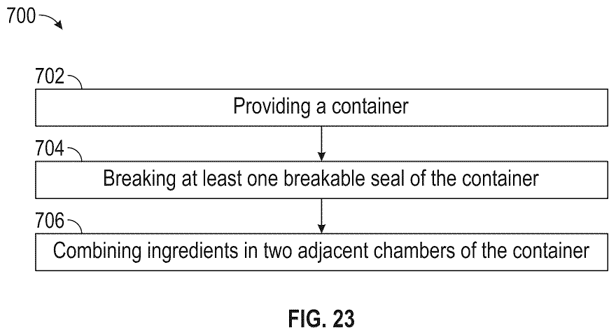

Further provided herein is a method for formulating a drug. FIG. 23 illustrates a flow chart of the method 700. The method can be used to formulate a drug.

At block 702, the method 700 can begin by providing the container described herein. The container can include a plurality of chambers and at least one breakable seal. Each chamber of the plurality of chambers can contain an ingredient. The at least one breakable seal can form a seal between two adjacent chambers of the plurality of chambers to separate the ingredients in the two adjacent chambers.

In some examples, the plurality of chambers can include a first chamber operable to receive a first ingredient, a second chamber operable to receive a second ingredient, and a third chamber operable to receive a third ingredient. In some examples, the at least one breakable seal can include a first breakable seal operable to separate the first chamber and the second chamber. In some examples, the first breakable seal allows the container to store the first ingredient and the second ingredient separately in the first chamber and the second chamber. In some examples, the at least one breakable seal can include a second breakable seal operable to separate the second chamber and the third chamber. In some examples, the second breakable seal allows the container to store the second ingredient and the third ingredient separately in the second chamber and the third chamber.

In some examples, the plurality of chambers can include one or more additional chambers. The one or more additional chambers can be operable to receive one or more additional ingredients. In some examples, the at least one breakable seal can include one or more additional breakable seals. The one or more additional breakable seals can be operable to separate the third chamber from the one or more additional chambers. It will be appreciated that when the one or more additional chambers include two or more additional chambers, a breakable seal can be included between each of the two or more additional chambers.

At block 704, the method 700 can include breaking the at least one breakable seal. The at least one breakable seal can be broken using any of the breaking methods described herein. For example, the breakable seal can be broken by peeling off and/or peeling apart a peelable seal. The breakable seal can be broken by adding a liquid to one of the adjacent chambers such that a pressure builds up to break the breakable seal. The breakable seal can be broken by adding a liquid to one of the adjacent chambers where the breakable seal is soluble and dissolves in the liquid. The breakable seal can be broken by applying a pressure via a roller to one of the adjacent chambers. The breakable seal can be broken by a user pressing down on one of the adjacent chambers, thereby providing sufficient pressure to break the breakable seal.

At block 706, the method 700 can include combining the ingredients in the two adjacent chambers of the container. In some examples, combining the ingredients simply includes breaking the breakable seal such that the ingredients flow into one another. In some examples, combining the ingredients includes mixing the ingredients. Mixing the ingredients can include any of the mixing methods described herein. For example, mixing the ingredients can include using a mechanical mixing device (e.g., device operable to rotate the container such that the ingredients mix, rocker plate to move the container, vibration means to vibrate the container, or other mechanical mixing devices). In some examples, mixing the ingredients can include manually mixing the ingredients. In some examples, manually mixing the ingredients can include a user rotating or otherwise moving the container.

In some examples, the at least one breakable seal can include a plurality of breakable seals. Each of the plurality of breakable seals can separate the ingredient in each chamber of the plurality of chambers.

The method 700 can further include breaking the plurality of breakable seals in a sequential order as described herein. Breaking the plurality of breakable seals in a sequential order can cause the ingredients in each of the plurality of chambers to combine in the sequential order. In some examples, after each breakable seal is broken, a mixing step can occur. The mixing step can be conducted as described herein.

In some examples, the container can further include a fitment chamber. The fitment chamber can include a fitment operable to receive and/or expel a fluid. In some examples, the fitment chamber can include the first chamber. In some examples, the fitment chamber can include an empty chamber adjacent to the first chamber. When the fitment chamber is an empty chamber adjacent to the first chamber, a breakable seal can be included between the fitment chamber and the first chamber. In some examples, the method 700 can further include receiving the fluid through the fitment into the fitment chamber. In some examples, the fluid can be operable to provide sufficient pressure to break the at least one breakable seal. In some examples, a first volume of fluid can provide a sufficient pressure to break the first breakable seal. A second volume of fluid can provide a sufficient pressure to break the second breakable seal. One or more additional volumes of fluid can be operable to break the one or more additional breakable seals. In some examples, the breakable seals can be soluble, such that injecting the fluid into the fitment chamber is operable to break the breakable seal.

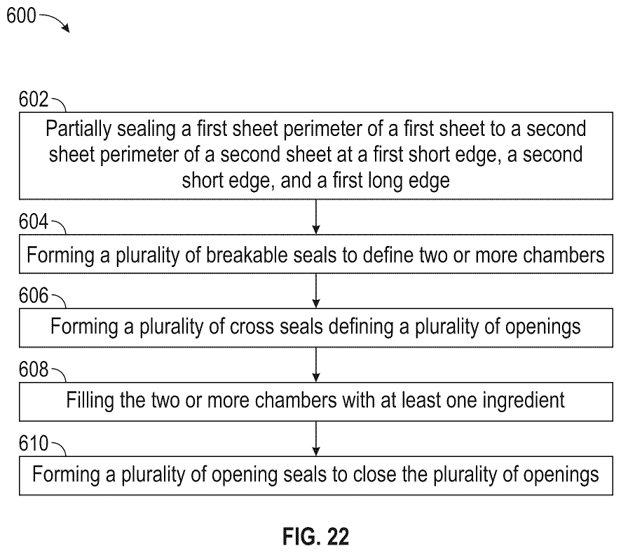

Further provided herein is a method for manufacturing, filling, and using a multi-compartment container. FIG. 22 illustrates a flow chart of the method 600. The method 600 can be used to manufacture, fill, and use the multi-compartment container described herein.

The method 600 can begin by providing a first layer and a second layer. In some examples, the first layer and the second layer can include a material that is non-adhesive. For example, the first layer and the second layer can include a material that prevents the ingredients from sticking to the first layer and the second layer. In some examples, the first layer and the second layer can include a plastic material. In some examples, the first layer and the second layer can include polyethylene. In some examples, the first layer and the second layer can include double wound low intensity polyethylene.

At block 602, the method 600 can include partially sealing a first layer perimeter of the first layer to a second layer perimeter of a second layer at a first short edge, a second short edge, and a first long edge. In some examples, the first short edge can be sealed using a permanent seal described herein. In some examples, the second short edge can be sealed using a permanent seal described herein. In some examples, the first long edge can be sealed using a permanent seal described herein. For example, the first layer and the second layer can be sealed along three edges of the perimeter using permanent seals. In some examples, the permanent seals can be formed utilizing heated jaws.

At block 604, the method 600 can include forming a plurality of breakable to define two or more chambers. The plurality of breakable seals can be operable to seal a portion of the first layer to a portion of the second layer. The plurality of breakable seals can separate the first layer and the second layer into two or more chambers.

At block 606, the method 600 can include forming a plurality of cross seals defining a plurality of openings. In some examples, each cross seal of the plurality of cross seals can intersect with a corresponding breakable seal of the plurality of breakable seals. The plurality of cross seals can have a gap between each of the plurality of cross seals defining an opening between each of the cross seals.

At block 608, the method 600 can include filling each of the two or more chambers with at least on ingredient through the plurality of openings. For example, a filling mechanism can be used to fill each of the two or more chambers with an ingredient through the plurality of openings.

At block 610, the method 600 can include forming a plurality of opening seals to close the plurality of openings. For example, the plurality of opening seals can seal the gaps between the plurality of cross seals, such that the ingredients are enclosed within each of the two or more chambers.

The method 600 can further include placing a fitment on a terminal chamber of the two or more chambers. The terminal chamber can be the chamber defined on one end by the first short edge or the second short edge. In some examples, the fitment can be inserted into the terminal chamber and welded in place, as described herein. In some examples, the fitment can include a fitment coupling mechanism. In some examples, the fitment coupling mechanism can be operable to removably couple to a liquid dispenser. For example, the fitment coupling mechanism can form a fluid tight seal with liquid dispenser. The terminal chamber can then receive a liquid from the liquid dispenser. In some examples, the liquid dispenser can include a syringe, a hose connected to a pump and reservoir, or another type of liquid dispenser.

The method 600 can further include attaching the liquid dispenser to the fitment coupling mechanism and providing a liquid to the terminal chamber via the liquid dispenser.

The method 600 can further include breaking one or more of the plurality of breakable seals such that the liquid mixes with the ingredient in at least one of the two or more chambers. In some examples, the pressure build up from providing the liquid is sufficient to break the breakable seal. In some examples, a user can press on the chamber to provide a pressure to break the breakable seal. In some examples, a roller can be used to break the breakable seal. In some examples, an automated system can be used to break the breakable seal (e.g., automated roller, automated liquid dispenser, etc.).

The method 600 can further include breaking all of the plurality of breakable seals such that the liquid mixes with the at least one ingredient in each of the two or more chambers. In some examples, the method 600 can further include mixing the ingredients in the multi-compartment container. For example, the ingredients can be manually mixed by a user kneading the multi-compartment container. In some examples, the ingredients can be mixed automatically (e.g., rocker plate, vibration mechanism, or other mechanical mixing). Once all the breakable seals are broken, the ingredients are all contained within the multi-compartment container between the permanent seals and thus can be mixed. The mixing of the ingredients can form the formulation.

The method 600 can further include attaching an administration device to the fitment coupling mechanism and removing the formulation via the administration device. In some examples, the administration device can include a syringe or another type of administration device. In other example, the administration device can include a hose and a pump which is operable to remove the formulation from the multi-compartment container and can fill other containers, such as vials, for later user.

The disclosures shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the examples described above may be modified within the scope of the appended claims.

What is claimed is:

1. A container comprising:
a first chamber operable to receive a first ingredient;
a second chamber operable to receive a second ingredient;
a third chamber operable to receive a third ingredient;
a first breakable seal operable to separate the first chamber and the second chamber; and
a second breakable seal operable to separate the second chamber and the third chamber,
wherein the first breakable seal is operable to break such that the first ingredient and the second ingredient are mixed to form a first mixture,
wherein the second breakable seal is operable to break such that the third ingredient and the first mixture are mixed to form a second mixture, and
wherein the first breakable seal is operable to break prior to the second breakable seal.

2. The container of claim 1, further comprising a fitment operable to receive and/or expel a fluid.

3. The container of claim 2, wherein the fitment includes a fitment coupling mechanism operable to couple to a liquid dispenser and/or administration device.

4. The container of claim 1, further comprising:
one or more additional chambers operable to receive one or more additional ingredients; and
one or more additional breakable seals operable to separate the one or more additional chambers from the third chamber,
wherein the one or more additional breakable seals are operable to break after the first breakable seal and the second breakable seal are broken.

5. The container of claim 1, further comprising a housing operable to enclose the first chamber, the second chamber, and the third chamber.

6. The container of claim 5, wherein the housing is formed from a first layer including a first layer perimeter and a second layer including a second layer perimeter.

7. The container of claim 6, further comprising a plurality of permanent seals operable to seal at least a portion of the first layer to at least a portion of the second layer.

8. The container of claim 7, wherein the plurality of permanent seals include a first short edge seal operable to seal the first layer perimeter to the second layer perimeter at a first short edge, a second short edge seal operable to seal the first layer perimeter to the second layer perimeter at a second short edge, and a first long edge seal operable to seal the first layer perimeter to the second layer perimeter at a first long edge.

9. The container of claim 7, wherein the plurality of permanent seals includes a first cross seal operable to intersect the first breakable seal and a second cross seal operable to intersect the second breakable seal, wherein the first cross seal is operable to define a first opening in communication with the first chamber, wherein the second cross seal is operable to device a second opening in communication with the second chamber and a third opening in communication with the third chamber, wherein the first opening is operable to receive the first ingredient into the first chamber, wherein the second opening is operable to receive the second ingredient into the second chamber, and wherein the third opening is operable to receive the third ingredient into the third chamber.

10. The container of claim 9, wherein the first cross seal and the second cross seal are operable to provide strength to the first breakable seal and the second breakable seal, respectively, such that the first breakable seal and the second breakable seal do not break when the first ingredient is received in the first chamber, the second ingredient is received in the second chamber, and the third ingredient is received in the third chamber.

11. The container of claim 9, wherein the plurality of permanent seals further include a first opening seal operable to seal the first opening, a second opening seal operable to seal the second opening, and a third opening seal operable to seal the third opening.

12. A method for formulating a drug, the method comprising:
providing a container comprising:
a first chamber operable to receive a first ingredient;
a second chamber operable to receive a second ingredient;
a third chamber operable to receive a third ingredient;
a first breakable seal operable to separate the first chamber and the second chamber; and
a second breakable seal operable to separate the second chamber and the third chamber;
breaking the first breakable seal;
mixing the first ingredient and the second ingredient to form a first mixture;
breaking the second breakable seal; and
mixing the first mixture with the third ingredient, thereby forming a second mixture.

13. The method of claim 12, wherein the container comprises one or more additional chambers operable to receive one or more additional ingredients and one or more additional breakable seals operable to separate the third chamber and the one or more additional chambers.

14. The method of claim 13, further comprising:
breaking the one or more additional breakable seals; and
mixing the second mixture with the one or more additional ingredients, thereby formulating the drug.

15. The method of claim 12, wherein the container further a fitment operable to receive and/or expel a fluid.

16. The method of claim 15, further comprising receiving a first volume of the fluid through the fitment into the first chamber.

17. The method of claim 16, wherein the first volume of fluid is operable to provide sufficient pressure to break the first breakable seal.

18. The method of claim 17, further comprising receiving a second volume of the fluid through the fitment into the first chamber.

19. The method of claim 18, wherein the second volume of fluid is operable to provide sufficient pressure to break the second breakable seal.

20. The method of claim 12, wherein the first ingredient, the second ingredient, and the third ingredient are arranged in a sequential mixing order, wherein the sequential mixing order expedites formulation of the drug.
